(19) United States
(12) Patent Application Publication
(10) Pub. No.: US 2024/0012864 A1
(43) Pub. Date: Jan. 11, 2024

(54) MULTI-PLATFORM DETECTION AND MITIGATION OF CONTENTIOUS ONLINE CONTENT

(71) Applicant: TRUST & SAFETY LABORATORY INC., Palo Alto, CA (US)

(72) Inventors: Thomas Siegel, Palo Alto, CA (US); Shankar Ravindra Ponnekanti, Sunnyvale, CA (US); Benjamin Philip Loney, Whitefish, MT (US)

(21) Appl. No.: 18/473,127

(22) Filed: Sep. 22, 2023

Related U.S. Application Data
(63) Continuation of application No. PCT/US22/21801, filed on Mar. 24, 2022.
(60) Provisional application No. 63/165,634, filed on Mar. 24, 2021.
(60) Provisional application No. 63/165,647, filed on Mar. 24, 2021.

(51) Int. Cl. G06F 16/9536

(52) U.S. Cl. CPC G06F 16/9536

(57) ABSTRACT

A system and method are provided for detecting, measuring, and/or mitigating contentious multi-platform content. The method includes recording any contentious content in one or more online platforms tagged by a plurality of users, while the plurality of users are searching the one or more online platforms according to a specified criteria. The method also includes analyzing actions of the one or more online platforms to determine an extent of contentious content in the one or more online platforms tagged by the plurality of users. The method also includes generating a report indicating the extent of contentious content, for the one or more online platforms. In some implementations, the method also includes providing, to the plurality of users, an interface that specifies the criteria for identifying contentious content in the one or more online platforms.

### RELATED APPLICATIONS

This application is a continuation of PCT Application Serial No. PCT/US2022/021801, filed on Mar. 24, 2022, entitled “Multi-Platform Detection And Mitigation of Contentious Online Content,” which claims the benefit of U.S. Provisional Patent Application Ser. No. 63/165,634, filed on Mar. 24, 2021, entitled “Multi-Platform Detection And Mitigation of Contentious Content Using Knowledge Graph And Social Graph Expansion,” and the benefit of U.S. Provisional Patent Application Ser. No. 63/165,647, filed on Mar. 24, 2021, entitled “Platform-Independent Measurements of Contentious Social Media Content,” each of which is herein fully incorporated by reference in its respective entirety.

### TECHNICAL FIELD

The disclosed implementations relate generally to detection and mitigation of contentious content online, and more specifically to systems and methods, for multi-platform detection and mitigation of contentious online content.

### BACKGROUND

Today there is more bad content found online than ever before in the history of the web, and it's influence and propensity to harm people has never been greater. Despite investing large amounts of resources and building elaborate processes, social media and other technology platforms are unable to protect their users with their existing tools and systems. The ubiquity of bad content across the web and its interconnectedness presents a major challenge to police this content, but it's also an opportunity to leverage these very same properties to fight it.

Moreover, trust in content on the web is broken. A lot of bad content is freely available online, harming and creating risks for many internet users. A critical issue is that there are currently no ways to measure volumes, severity, discoverability and impact that bad content has on internet users, and existing assessments are speculative at best. Conventional systems do not measure online health indicators reliably, and platforms, regulators and interested third parties, lack tools for determining a baseline, set goals and track progress, for making the web safer and more enjoyable for all users.

### SUMMARY

Accordingly, there is a need for systems and methods that enable detection and mitigation of bad content online. Techniques described herein use a novel content knowledge graph, generated based on cross platform content and metadata, that greatly improves precision and recall to classify bad content online. Subsequently, the systems analyzes cross platform social graph information including network of entities creating, sharing and interacting with bad content, to increase accuracy of detecting bad content and expands coverage to find more, related bad content. Some implementations use supervised learning techniques, construct and use superior ground truth datasets, leveraging crowdsourced labeling, that is continuous, near real-time, and avoids bias. The present disclosure describes a system and method that addresses some of the shortcomings of conventional methods and systems. The methods detect abuse trends faster than conventional methods, provide improved precision and recall, provide improved coverage by tackling abuses that are not handled by traditional methods, and provide better cost-effective solution, when compared to other conventional methods.

Also, there is a need for platform-independent technologies that measure the severity and frequency of contentious content. When objectionable content is found, such content is automatically reported and monitored to map detailed platform actions. Some implementations track expert searches across social media platforms for measurements. By polling real public perception for every piece of content, some implementations objectively benchmark policy severity against user expectations and industry standards.

The present disclosure describes a system and method that addresses some of the shortcomings of conventional methods and systems.

In accordance with some implementations, a method for detecting and mitigating contentious multi-platform content executes at a computing system. Typically, the computing system includes a single computer or workstation, or a plurality of computers, each having one or more CPU and/or GPU processors and memory.

The method includes obtaining a plurality of target contents from a plurality of online platforms that operate independently from each other. The online platforms contain at least some similar contentious information. The method also includes identifying contentious content across the plurality of online platforms, by building a knowledge graph, based on semantic metadata extracted from the plurality of target contents. The method also includes computing strength of relationships between entities, across the plurality of platforms, to construct clusters that relate to the contentious content. The method also includes triggering an enforcement action corresponding to the contentious content, for a target online platform, based on the clusters.

In some implementations, obtaining the plurality of target contents includes retrieving and aggregating media content, on a predetermined topic, from the plurality of online platforms. In some implementations, the media content includes multi-media content shared by users of the plurality of online platforms. In some implementations, the predetermined topic is received from a user.

In some implementations, obtaining the plurality of target contents includes operations performed on the plurality of online platforms, the operations selected from the group consisting of: crawling, scraping, and accessing APIs and direct sharing agreements.

In some implementations, obtaining the plurality of target contents includes using keywords, hashtags, hashes, content matching, account property matching, or machine learning algorithms, to identify the plurality of target contents from content posted by users of the plurality of online platforms.

In some implementations, obtaining the plurality of target contents includes collecting, reformatting, and storing content, from the plurality of online platforms, to a relational database, continuously on a periodic basis.

In some implementations, extracting the semantic metadata further includes linking the semantic metadata to relevant content of the plurality of target contents, in a relational database.

In some implementations, the semantic metadata includes account and engagement information for users of the plurality of online media platforms.

In some implementations, computing the strength of relationships includes identifying and scoring common relationships between accounts, groups, content and the semantic metadata.

In some implementations, computing the strength of relationships includes traversing a social graph representing the relationships and numerically scoring a quality of the social graph for any contentious content and accounts, thereby constructing the clusters with similar abuse features or risk vectors.

In some implementations, the method further includes: obtaining, from one or more users, one or more labels indicating severity of badness for the plurality of target contents; and constructing the clusters that relate to the contentious content further based on the one or more labels. In some implementations, the method further includes selecting a set of labels from the one or more labels based on determining quality and consistency of the one or more labels, and constructing the clusters is further based on the set of labels. In some implementations, the one or more labels are combined algorithmically into a single trust score to label each content of the plurality of target contents. In some implementations, the one or more labels are defined specifically for each abuse category. In some implementations, the one or more labels provide consistent risk labels across media formats, languages and products, in each abuse category

In some implementations, the method further includes providing one or more APIs for the target online platform, to access at least a portion of the contentious content or the cluster, the one or more APIs configured to trigger the enforcement action.

In some implementations, the enforcement action includes one or more operations selected from the group consisting of: removal of the contentious content from the target online platform, generating one or more warnings for the contentious content, and generating an alert for a user to examine the contentious content.

In another aspect, a method is provided for training machine learning classifiers for detecting contentious multi-platform content. The method includes obtaining a plurality of target contents from a plurality of online platforms that operate independently from each other. The method also includes identifying contentious content across the plurality of online platforms, by building a knowledge graph, based on semantic metadata extracted from the plurality of target contents. The method also includes forming feature vectors based on the semantic metadata, and training one or more machine learning classifiers to detect contentious content in contents of a target online platform, according to a user-specified policy, based on the feature vectors.

In some implementations, the method further includes providing a self-service interface for specifying policies related to online content moderation, and receiving the user-specified policy via the interface.

In some implementations, the method further includes receiving a first user input specified using natural language; and performing one or more natural language processing algorithms on the first user input to determine the user-specified policy.

In some implementations, the method further includes generating a fact-check database based on misinformation obtained from one or more third-party providers distinct from the plurality of online platforms; and forming the feature vectors further based on the fact-check database.

In some implementations, the method further includes: continuously monitoring the one or more third-party providers to determine any changes in truth value of the misinformation; and, in accordance with a determination that the truth value of the misinformation has changed, updating the fact-check database, and the feature vectors, and retraining the one or more machine learning classifiers to detect the contentious content.

In some implementations, forming the feature vectors includes performing one or more stance detection algorithms on the metadata.

In another aspect, a method is provided for detecting and measuring objectionable multi-platform content executes at a computing system. The method includes recording any contentious content in one or more online platforms tagged by a plurality of users, while the plurality of users are searching the one or more online platforms according to a specified criteria. The method also includes analyzing actions of the one or more online platforms to determine an extent of contentious content in the one or more online platforms tagged by the plurality of users. The method also includes generating a report indicating the extent of contentious content, for the one or more online platforms.

In some implementations, the method also includes providing, to the plurality of users, an interface that specifies the criteria for identifying contentious content in the one or more online platforms.

In some implementations, analyzing actions of the one or more online platforms includes monitoring and reporting time taken by the one or more online platforms to take action on any contentious content tagged by the plurality of users.

In some implementations, analyzing actions of the one or more online platforms includes monitoring and reporting sharing, of any objectionable content that is tagged by the plurality of users, on the one or more online platforms.

In some implementations, recording any contentious content tagged by the plurality of users is performed for a predetermined period of time.

In some implementations, recording any contentious content tagged by the plurality of users includes obtaining screen shots of any tagged contentious content.

In some implementations, the criteria specify whether to search for specific text, images or other media snippets.

In some implementations, the criteria specify a narrative of abuse behavior, or entities or bad actors to search for, when searching the one or more online platforms.

In some implementations, the method further includes providing generic or predefined user profiles to ensure a realistic user experience for the plurality of users on the one or more online platforms.

In some implementations, disguising the plurality of users from the one or more online platforms by performing one or more operations selected from the group consisting of: providing generic or predefined user profiles; refreshing a browser used by the plurality of users for searching the one or more online platforms, on a periodic basis; rotating proxies, locations, or other geographic markers, used for browsing by the plurality of users; and changing protocol used for browsing by the plurality of users.

In some implementations, the method further includes obtaining labels, from the plurality of users, indicating severity of any contentious content tagged by the plurality of users, and using the labels to generate the report. In some implementations, the labels include a misinformation label, and the plurality of users assign the misinformation label based on an aggregate weighted score that includes absurdity, fairness, inauthenticity, or propensity for harm, of any contentious content tagged by the plurality of users. In some implementations, the method further includes processing the labels to ensure quality or consistency of labeling, by normalizing and combining the labels algorithmically into a single trust score, thereby labelling any tagged contentious content for severity. In some implementations, the labels are provided to the plurality of users, and include one or more labels selected from the group consisting of: content labels defined specifically for each category of abusive content, and risk labels within each content label, including permutations for different media formats, and languages in each abuse category. In some implementations, the method further includes generating synthetic content that includes one or more contentious content, uploading the synthetic content using generic or pre-defined user profiles, to the one or more online platforms, and measuring and reporting time taken by the one or more online platforms to remove the synthetic content.

In some implementations, the method further includes reporting a contentious content, hosted by a target online platform and labeled, by the plurality of users, to have a minimum severity score, to the target online platform, using the target online platform's content moderation complaint mechanism. In some implementations, monitoring the target online platform to determine a reaction time for the target online platform to remove the contentious content; and generating the report for the target online platform further based on the reaction time.

In some implementations, the method further includes computing and reporting one or more statistical insights on any contentious content tagged by the plurality of users.

In some implementations, the method further includes reporting public perception of any contentious content tagged by the plurality of users.

In some implementations, a computing system includes one or more computers. Each of the computers includes one or more processors and memory. The memory stores one or more programs that are configured for execution by the one or more processors. The one or more programs include instructions for performing any of the methods described herein.

In some implementations, a non-transitory computer readable storage medium stores one or more programs configured for execution by a computing system having one or more computers, each computer having one or more processors and memory. The one or more programs include instructions for performing any of the methods described herein.

The present application discloses subject-matter in correspondence with the following numbered clauses:

(A1) A method for detecting and measuring contentious multi-platform content and algorithmic bias, comprising: recording any contentious content in one or more online platforms tagged by a plurality of users, while the plurality of users are searching the one or more online platforms according to a specified criteria; analyzing actions of the one or more online platforms to determine an extent of contentious content in the one or more online platforms tagged by the plurality of users; and generating a report indicating the extent of contentious content, for the one or more online platforms.

(A2) The method as recited in clause (A1), further comprising: providing, to the plurality of users, an interface that specifies criteria for identifying contentious content in the one or more online platforms.

(A3) The method as recited in any of clauses (A1)-(A2), wherein analyzing actions of the one or more online platforms comprises monitoring and reporting time taken by the one or more online platforms to take action on any contentious content tagged by the plurality of users.

(A4) The method as recited in any of clauses (A1)-(A3), wherein analyzing actions of the one or more online platforms comprises monitoring and reporting sharing, of any objectionable content that is tagged by the plurality of users, on the one or more online platforms.

(A5) The method as recited in any of clauses (A1)-(A4), wherein recording any contentious content tagged by the plurality of users is performed for a predetermined period of time.

(A6) The method as recited in any of clauses (A1)-(A5), wherein recording any contentious content tagged by the plurality of users includes obtaining screen shots of any tagged contentious content.

(A7) The method as recited in clause (A2), wherein the criteria specify (i) whether to search for specific text, images or other media snippets, or (ii) a narrative of abuse behavior, or entities or bad actors to search for, when searching the one or more online platforms

(A8) The method as recited in any of clauses (A1)-(A7), further comprising: providing generic or predefined user profiles to ensure a realistic user experience for the plurality of users on the one or more online platforms.

(A9) The method as recited in any of clauses (A1)-(A8), further comprising: disguising the plurality of users from the one or more online platforms by performing one or more operations selected from the group consisting of: providing generic or predefined user profiles; refreshing a browser used by the plurality of users for searching the one or more online platforms, on a periodic basis; rotating proxies, locations, or other geographic and device markers, used for browsing by the plurality of users; and changing protocol used for browsing by the plurality of users.

(A10) The method as recited in any of clauses (A1)-(A9), further comprising: obtaining labels, from the plurality of users, indicating severity of any contentious content tagged by the plurality of users, and using the labels to generate the report.

(A11) The method as recited in clause (A10), wherein the labels include a misinformation label, and the plurality of users assign the misinformation label based on an aggregate weighted score that includes absurdity, fairness, inauthenticity, or propensity for harm, of any contentious content tagged by the plurality of users.

(A12) The method as recited in clause (A10), further comprising: processing the labels to ensure quality or consistency of labeling, by normalizing and combining the labels algorithmically into a single trust score, thereby labelling any tagged contentious content for severity.

(A13) The method as recited in clause (A10), wherein the labels are provided to the plurality of users, and include one or more labels selected from the group consisting of: content labels defined specifically for each category of abusive content, and risk labels within each content label, including permutations for different media formats, and languages in each abuse category.

(A14) The method as recited in any of clauses (A1)-(A13), further comprising: generating synthetic content that includes one or more contentious content; uploading the synthetic content using generic or pre-defined user profiles, to the one or more online platforms; and measuring and reporting time taken by the one or more online platforms to remove the synthetic content.

(A15) The method as recited in any of clauses (A1)-(A14), further comprising: reporting a contentious content, hosted by a target online platform and labeled, by the plurality of users, to have a minimum severity score, to the target online platform, using the target online platform's content moderation complaint mechanism.

(A16) The method as recited in clause (A15), further comprising: monitoring the target online platform to determine a reaction time for the target online platform to remove the contentious content; and generating the report for the target online platform further based on the reaction time.

(A17) The method as recited in any of clauses (A1)-(A16), further comprising: computing and reporting one or more statistical insights on any contentious content tagged by the plurality of users.

(A18) The method as recited in any of clauses (A1)-(A17), further comprising: reporting public perception of any contentious content tagged by the plurality of users.

(A19) The method as recited in any of clauses (A1)-(A18), further comprising: causing the one or more online platforms to provide contentious content to the plurality of users; and measuring and reporting (i) severity of the contentious content relative to a training set, (ii) time taken for the one or more online platforms to provide the contentious content, and (ii) persistence of the contentious content on the one or more online platforms.

(B1) A method for detecting and mitigating contentious multi-platform content, comprising: obtaining a plurality of target contents from a plurality of online platforms that operate independently from each other; identifying contentious content across the plurality of online platforms, by building a knowledge graph, based on semantic metadata extracted from the plurality of target contents; computing strength of relationships between entities, across the plurality of platforms, to construct clusters that relate to the contentious content; and triggering an enforcement action corresponding to the contentious content, for a target online platform, based on the clusters.

(B2) The method as recited in clause (B1), wherein obtaining the plurality of target contents comprises retrieving and aggregating media content, on a predetermined topic, from the plurality of online platforms.

(B3) The method as recited in clause (B2), wherein the media content comprises multi-media content shared by users of the plurality of online platforms.

(B3) The method as recited in clause (B2), wherein the predetermined topic is received from a user.

(B4) The method as recited in any of clauses (B1)-(B3), wherein obtaining the plurality of target contents comprises operations performed on the plurality of online platforms, the operations selected from the group consisting of: crawling, scraping, and accessing APIs and direct sharing agreements.

(B5) The method as recited in any of clauses (B1)-(B4), wherein obtaining the plurality of target contents comprises using keywords, hashtags, hashes, content matching, account property matching, or machine learning algorithms, to identify the plurality of target contents from content posted by users of the plurality of online platforms.

(B6) The method as recited in any of clauses (B1)-(B5), wherein obtaining the plurality of target contents comprises collecting, reformatting, and storing content, from the plurality of online platforms, to a relational database, continuously on a periodic basis.

(B7) The method as recited in any of clauses (B1)-(B6), wherein extracting the semantic metadata further comprises linking the semantic metadata to relevant content of the plurality of target contents, in a relational database.

(B8) The method as recited in any of clauses (B1)-(B7), wherein the semantic metadata includes account and engagement information for users of the plurality of online media platforms.

(B9) The method as recited in any of clauses (B1)-(B8), wherein computing the strength of relationships includes identifying and scoring common relationships between accounts, groups, content and the semantic metadata.

(B10) The method as recited in any of clauses (B1)-(B9), wherein computing the strength of relationships includes traversing a social graph representing the relationships and numerically scoring a quality of the social graph for any contentious content and accounts, thereby constructing the clusters with similar abuse features or risk vectors.

(B11) The method as recited in any of clauses (B1)-(B10), further comprising: obtaining, from one or more users, one or more labels indicating severity of badness for the plurality of target contents; and constructing the clusters that relate to the contentious content further based on the one or more labels.

(B12) The method as recited in clause (B11), further comprising: selecting a set of labels from the one or more labels based on determining quality and consistency of the one or more labels; and wherein constructing the clusters is further based on the set of labels.

(B13) The method as recited in clause (B11), wherein the one or more labels are combined algorithmically into a single trust score to label each content of the plurality of target contents.

(B14) The method as recited in clause (B11), wherein the one or more labels are defined specifically for each abuse category.

(B15) The method as recited in clause (B14), wherein the one or more labels provide consistent risk labels across media formats, languages and products, in each abuse category.

(B16) The method as recited in any of clauses (B1)-(B15), further comprising: providing one or more APIs for the target online platform, to access at least a portion of the contentious content or the cluster, the one or more APIs configured to trigger the enforcement action.

(B17) The method as recited in any of clauses (B1)-(B16), wherein the enforcement action comprises one or more operations selected from the group consisting of: removal of the contentious content from the target online platform, generating one or more warnings for the contentious content, and generating an alert for a user to examine the contentious content.

(C1) A method for training machine learning classifiers for detecting contentious multi-platform content, comprising: obtaining a plurality of target contents from a plurality of online platforms that operate independently from each other; identifying contentious content across the plurality of online platforms, by building a knowledge graph, based on semantic metadata extracted from the plurality of target contents; forming feature vectors based on the semantic metadata; and training one or more machine learning classifiers to detect contentious content in contents of a target online platform, according to a user-specified policy, based on the feature vectors.

(C2) The method as recited in clause (C1), further comprising: providing a self-service interface for specifying policies related to online content moderation; and receiving the user-specified policy via the interface.

(C3) The method as recited in any of clauses (C1)-(C2), further comprising: receiving a first user input specified using natural language; and performing one or more natural language processing algorithms on the first user input to determine the user-specified policy.

(C4) The method as recited in any of clauses (C1)-(C3), further comprising: generating a fact-check database based on misinformation obtained from one or more third-party providers distinct from the plurality of online platforms; and forming the feature vectors further based on the fact-check database.

(C5) The method as recited in clause (C4), further comprising: continuously monitoring the one or more third-party providers to determine any changes in truth value of the misinformation; and in accordance with a determination that the truth value of the misinformation has changed, updating the fact-check database, and the feature vectors, and retraining the one or more machine learning classifiers to detect the contentious content.

(C6) The method as recited in clause (C5), wherein forming the feature vectors comprises performing one or more stance detection algorithms on the metadata.

(D1) A method for detecting and mitigating contentious multi-platform content, comprising: obtaining target contents from a target online platform; extracting metadata from the target contents; forming feature vectors based on the metadata; and detecting contentious content in the target contents by inputting the feature vectors to one or more trained machine learning classifiers, wherein the trained machine learning classifiers are trained, on a plurality of target contents from a plurality of online platforms, to detect a class of contentious contents, according to a user-specified metric.

(E1) An electronic device, comprising: one or more processors; and memory storing one or more programs for execution by the one or more processors, the one or more programs including instructions for performing any of the method as recited in clauses (A1)-(D1).

(F1) A non-transitory computer-readable storage medium storing one or more programs for execution by one or more processors of an electronic device, the one or more programs including instructions for performing any of the method as recited in clauses (A1)-(D1).

### BRIEF DESCRIPTION OF THE DRAWINGS

For a better understanding of the disclosed systems and methods, as well as additional systems and methods, reference should be made to the Description of Implementations below, in conjunction with the following drawings in which like reference numerals refer to corresponding parts throughout the figures.

FIG. 1A shows a block diagram of a system for detecting and/or mitigating contentious multi-platform content, in accordance with some implementations.

FIG. 1B is a block diagram of a system for detecting and measuring contentious multi-platform content, in accordance with some implementations.

FIGS. 2A, 2B and 2C show a block diagram of a computing device system for detecting, measuring and/or mitigating contentious multi-platform content, according to some implementations.

FIGS. 3A-3L is a flowchart of an example process for detecting and mitigating contentious multi-platform content, according to some implementations.

FIGS. 4A-4E is a flowchart of an example process for training machine learning classifiers for detecting and mitigating contentious multi-platform content, according to some implementations.

FIG. 5 is a flowchart of an example process for using machine learning classifiers for detecting and mitigating contentious multi-platform content, according to some implementations.

FIGS. 6A-6N is a flowchart of an example process for detecting and mitigating contentious multi-platform content, in accordance with some implementations.

FIGS. 7A-7H show examples of disinformation, misinformation, and mal-information, and associated handling, processing, and/or reporting such content, in accordance with some implementations.

FIG. 8 shows an example visualization of speed of response for platforms, according to some implementations.

FIG. 9 shows an example visualization of findability of bad content, according to some implementations.

FIG. 10 shows an example visualization of enforcement strictness for the platforms shown in FIGS. 8 and 9, according to some implementations.

FIG. 11 shows an example visualization of proactive defenses for the platforms shown in FIGS. 8 and 9, according to some implementations.

FIG. 12 shows a flow diagram of an example process for measuring and monitoring platform response, according to some implementations.

FIG. 13 is a graphical user interface with a dashboard that provides users of the system with a visualization of findability rate, according to some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

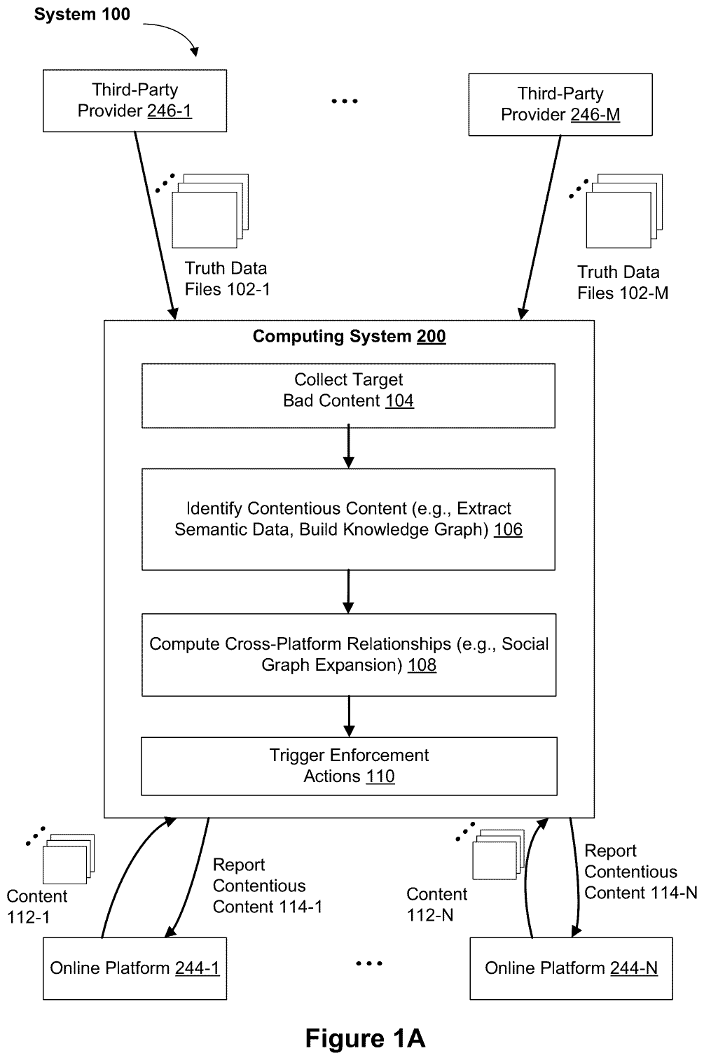

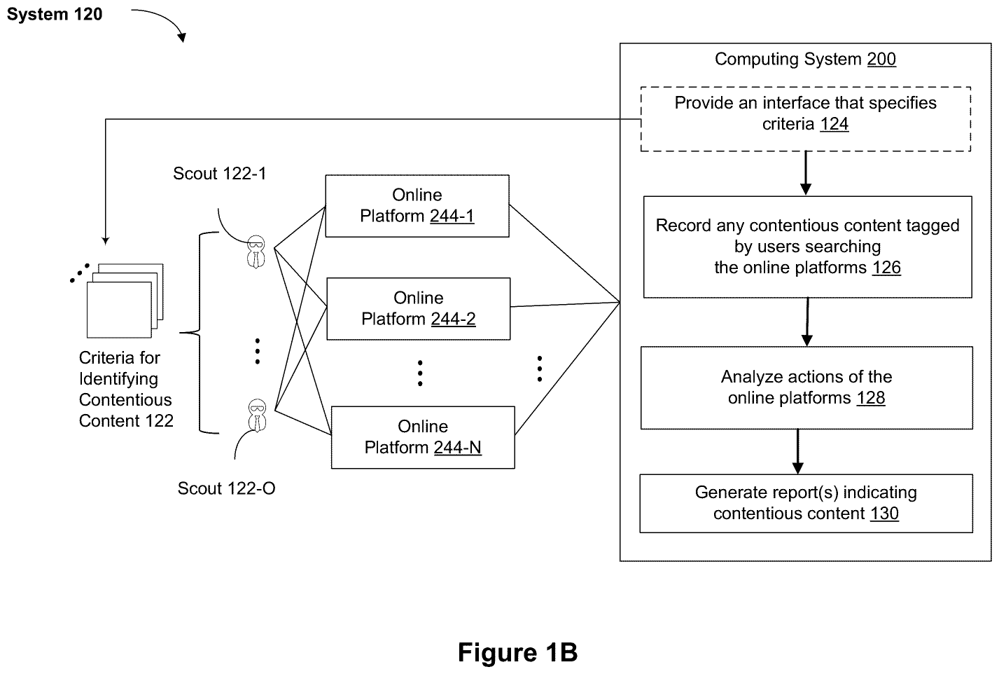

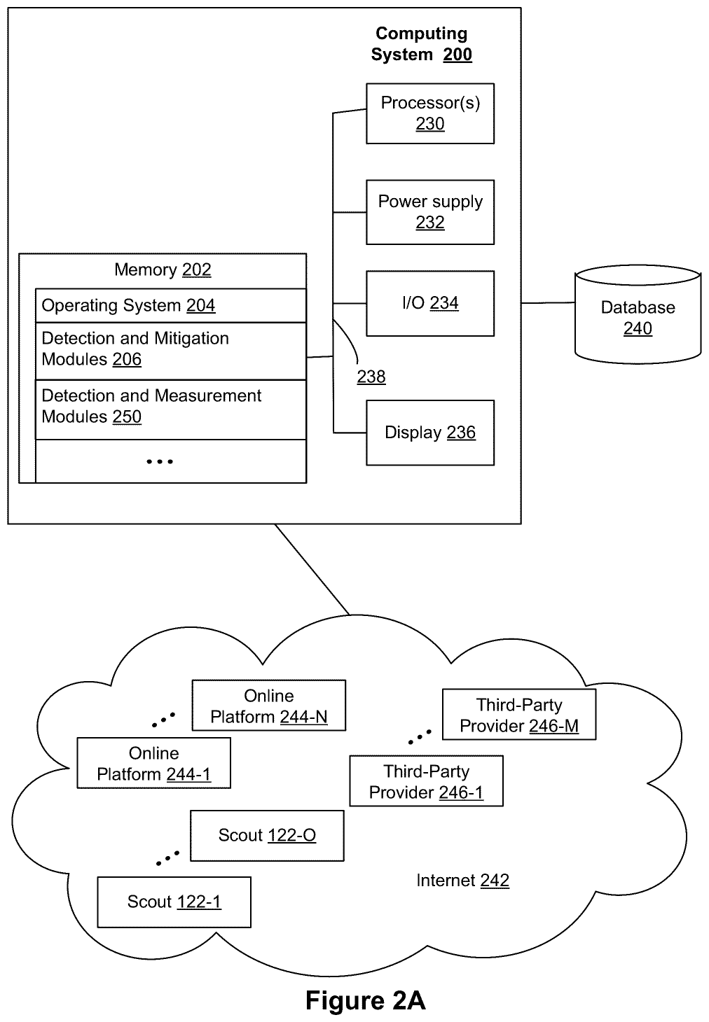

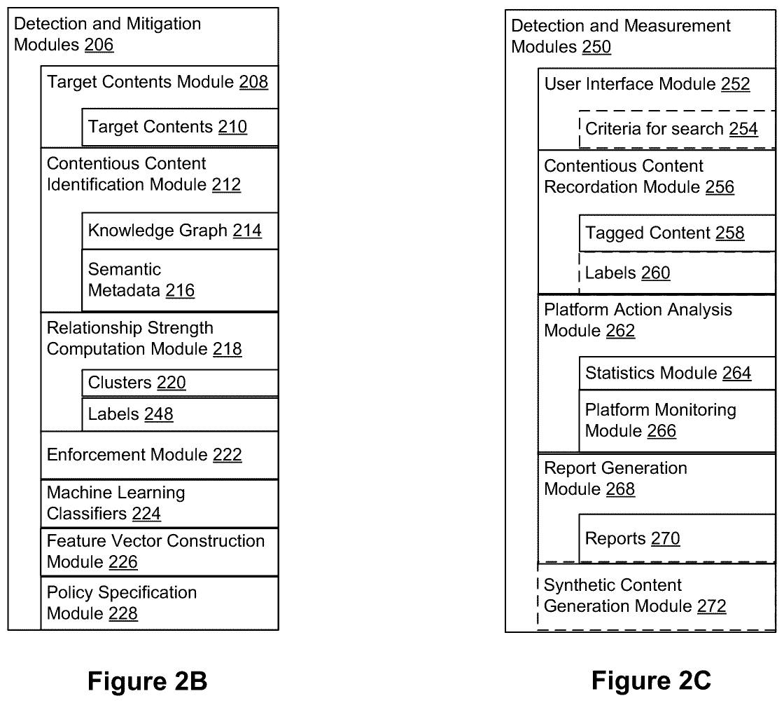

FIG. 1A is a diagram of a system 100 for detecting and/or mitigating contentious content across multiple online platforms, in accordance with some implementations. A computing system 200 (details of which are described below in reference to FIGS. 2A-2C) collects (104) target bad content (e.g., content 112-1, . . . , 112-N) from a plurality of online platforms (e.g., platforms 244-1, . . . , 244-N). The online platforms include distinct social media platforms, such as Twitter and Reddit, that operate independently from each other. The system 200 also identifies (106) contentious content (e.g., by extracting semantic data from the target content, and building a knowledge graph based on the extracted metadata), computes (108) cross-platform relationships (sometimes called social graph expansion) for the contentious content, and triggers (110) enforcement actions, for the online platforms. The enforcement actions may be in the form of reports generated for particular online platforms reported (114) to the online platforms. In some implementations, truth data (e.g., data files 102-1, . . . , 102-M) from one or more third-party providers (e.g., providers 246-1, . . . , 246-M) are used to inform the steps of the computing system 200. The computing system 200 continuously receives (e.g., on a periodic basis, such as once a day or every few hours) the truth data from the third-party providers and uses the data to detect and/or mitigate contentious content in the online platforms 244, according to some implementations. Some implementations collect targeted bad content data from across the web, link relevant content and metadata, and use social graph expansion, to identify related bad content across the web. Some implementations generate content labels and severity scores to classify this content using a labelling process. In some implementations, the annotations and trust scores (sometimes called severity scores) applied to content (e.g., web pages, snippets, posts, accounts) are ingested by social media platforms to inform improved removal and warning label actions.

FIG. 1B is a diagram of a system 120 for detecting and/or measuring contentious multi-platform content, in accordance with some implementations. The computing system 200 (details of which are described below in reference to FIGS. 2A-2C) records (126) any contentious content tagged by users (e.g., scouts 122-1, . . . , 122-O, that may include human scouts, bots, and/or machine learning algorithms) searching one or more online platforms (e.g., platforms 244-1, . . . , 244-N). The online platforms include distinct social media platforms, such as Twitter and Facebook, that may operate independently from each other. The system 200 also analyzes (128) actions of the online platforms (e.g., actions taken by the platforms to take down contentious content tagged by the users), and generates (130) report(s) indicating contentious content. In some implementations, the system provides (124) an interface that specifies criteria 102 for the users to search the online platforms. These aspects are further described below, in accordance with some implementations. The computing system 200 shown in FIG. 1B may include operations or modules from the computing system 200 shown in FIG. 1A and vice-versa.

According to some implementations, the system 200 measures and/or monitors online platform(s), assesses the riskiness that bad user generated content poses for the platform(s) that hosts the content. Some implementations include a combined methodology, process and tool that measures findability and severity of bad content online, as well as the efficiency and effectiveness of removal efforts by platforms hosting such content. To improve reliability and actionability of the measurement, the system 200 according to some implementations works anonymously from a platform and user point of view, and allows direct comparison among platforms for benchmarking. In some implementations, human scouts (or automated systems) spend a defined period of time searching for bad content, repeating the process for all participating platforms. This content is then labelled for severity. Optionally, the system uploads similar pieces of content to all platforms. The content is then flagged to the platform as problematic and the system measures if and when the content gets actioned on. In some implementations, collected cross-platform information undergoes a statistical analysis to process these results and generates additional insights, such as user sentiment analysis that is presented in the form of numbers, charts, tables and reports.

FIGS. 2A-2C show a block diagram of the computing system 200 for detecting, measuring, and/or multi-platform contentious content in accordance with some implementations. The system 200 typically includes one or more processor(s) 230, a memory 202, a power supply 232, an input/output (I/O) subsystem 234, and a communication bus 238 for interconnecting these components. Processor(s) 230 execute modules, programs and/or instructions stored in memory 202 and thereby perform processing operations, including the methods described herein according to some implementations. In some implementations, the system 200 also includes a display 236 for displaying visualizations (e.g., reports of contentious platform, response times for online platforms). In some implementations, the system 200 generates displays or reports, and transmits the displays or reports to an online platform (e.g., online platforms 244-1, . . . , 244-N) for display. Some implementations of the system 200 include touch, selection, or other I/O mechanisms coupled via the I/O subsystem 234, to process input from users (e.g., input that selects (or deselects) visual elements of a displayed report). In some implementations, the system 200 obtains contents (sometimes called target contents) from the online platforms 244-1, . . . , 244-N (or software therein), and processes the target content. Some aspects of the system 200 (e.g., the modules in the memory 302) are implemented in the online platforms 244-1, . . . , 244-N, according to some implementations.

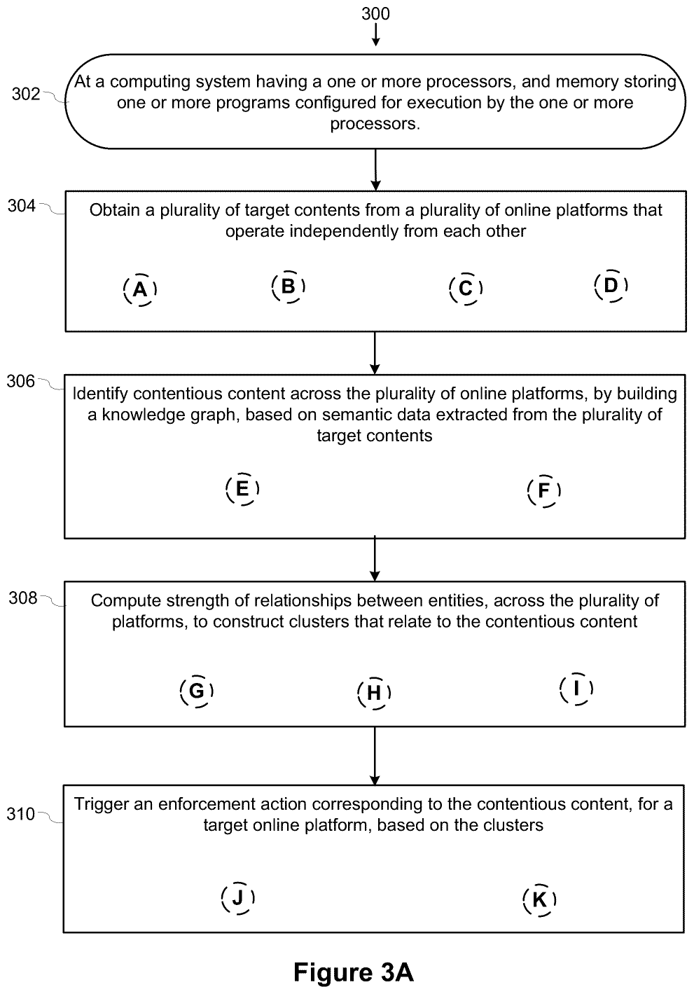

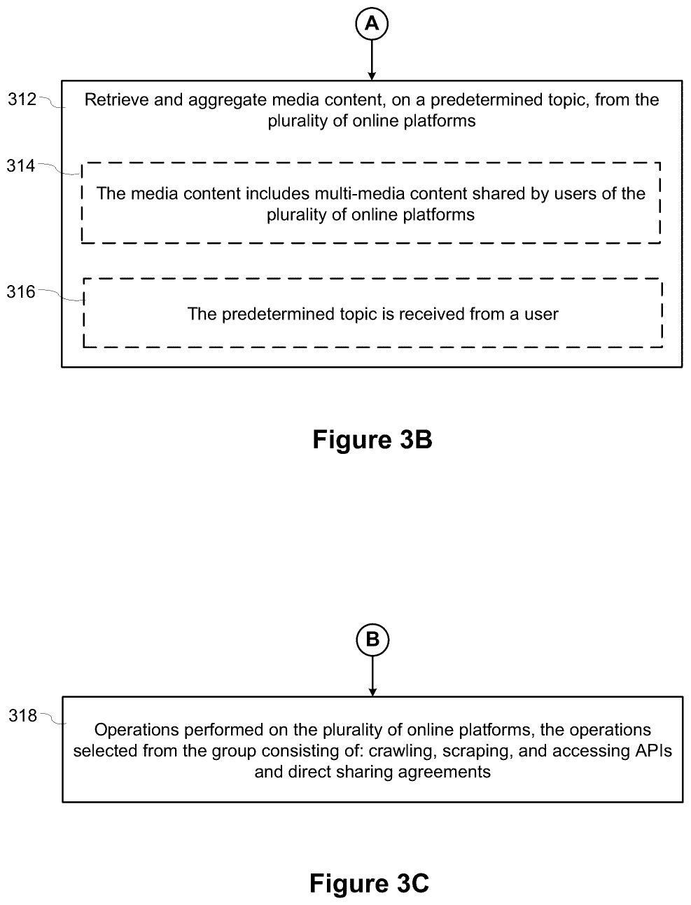

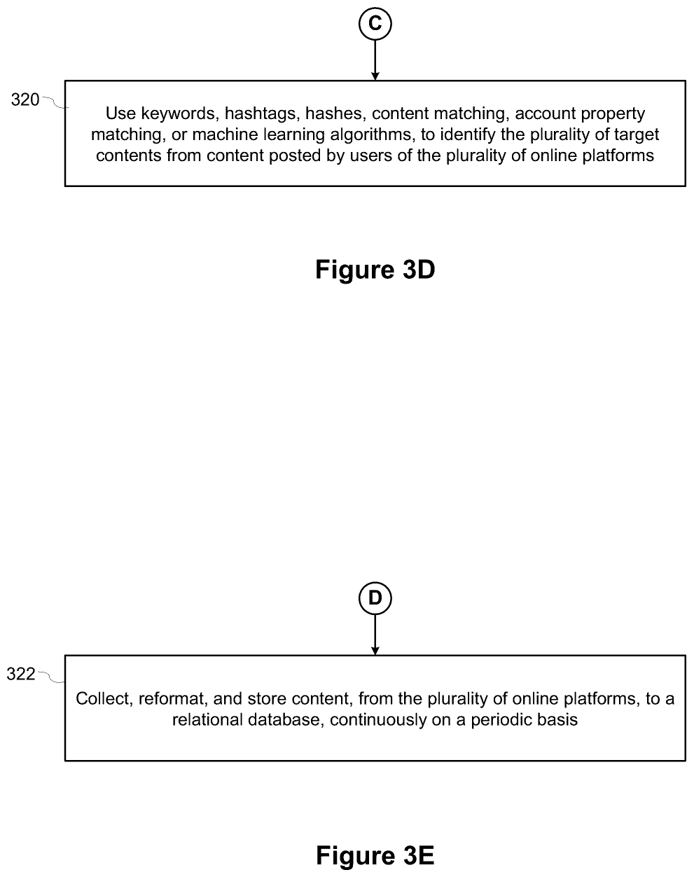

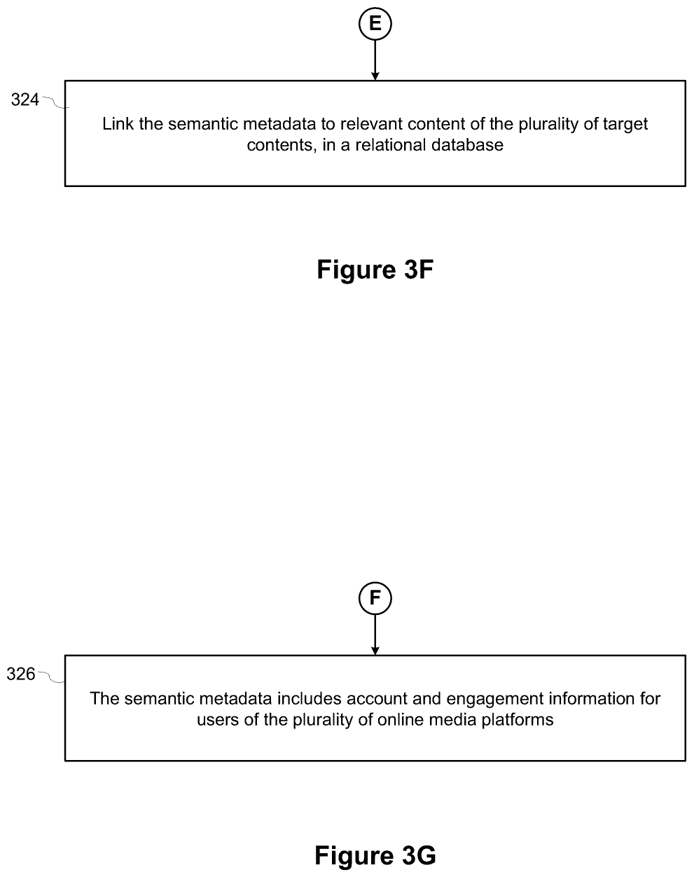

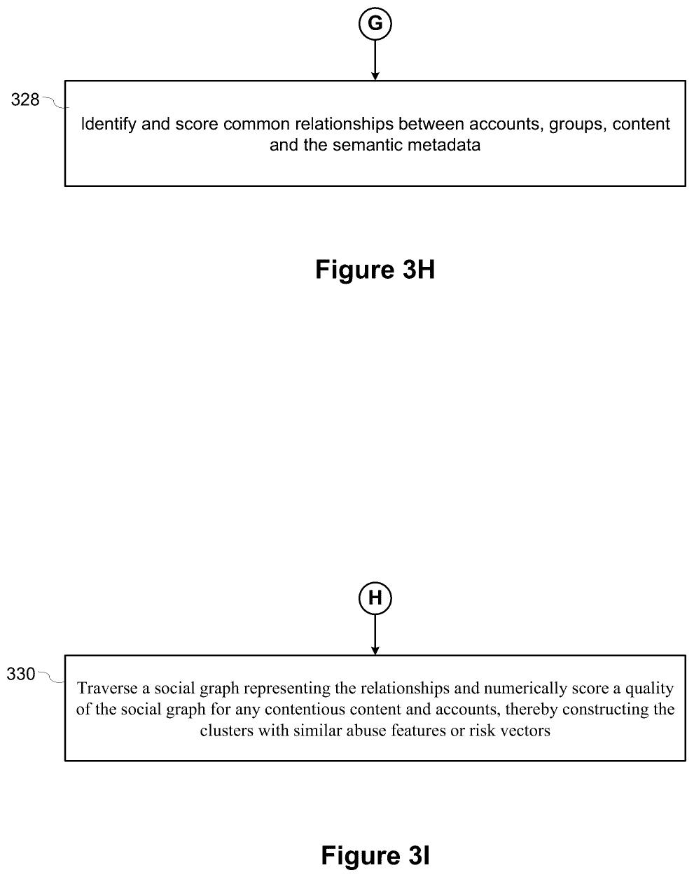

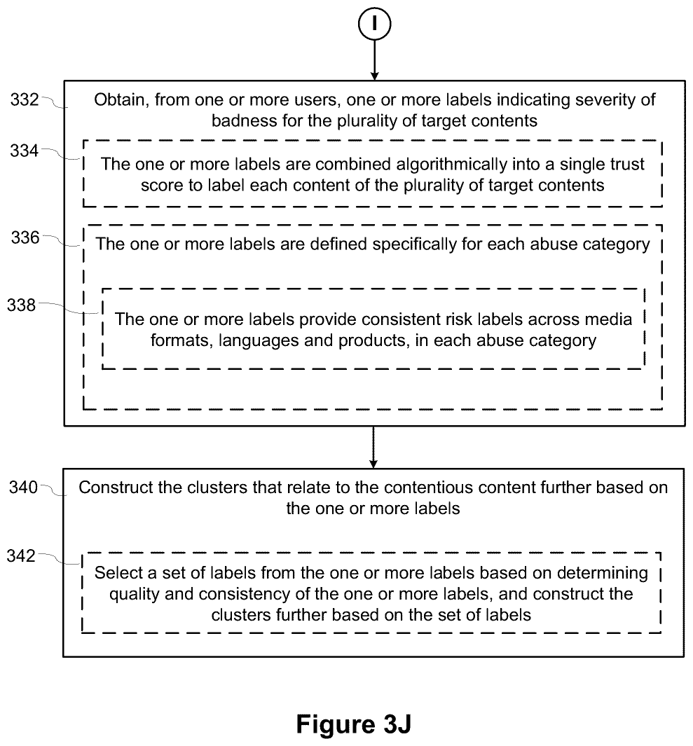

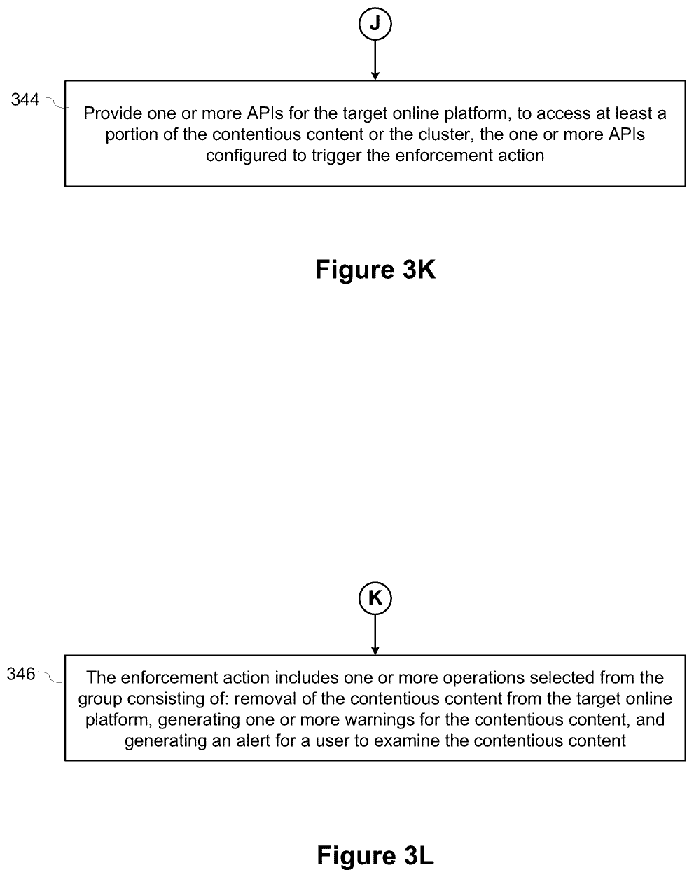

In some implementations, the memory 202 stores one or more programs (e.g., sets of instructions), and/or data structures, collectively referred to as “modules” herein. In some implementations, the memory 202, or the non-transitory computer readable storage medium of the memory 200, stores the following programs, modules, and data structures, or a subset or superset thereof, examples of which are described below in detail in reference to FIGS. 3A-3L, 4A-4E, 5, 6A-6N, 7A-7H, and 8-13:
an operating system 204;
an optional detection and/or mitigation modules 206 that include (as shown in FIG. 2B):
   a target contents module 208 configured to obtain target contents 210 from online platforms 244-1, . . . , 244-N, such as Twitter and Reddit. The target contents module 208 may retrieve and/or aggregate contents (e.g., multi-media contents) that may include web pages, web sites, or applications;
   a contentious content identification module 212 that includes modules for building knowledge graph 214, and extracting semantic metadata 216;
   a relationship strength computation module 218 that includes modules for building clusters 218 and/or labels 248;
   an enforcement module 222;
   optionally machine learning classifiers 224 for training and/or using one or more machine learning classifiers for detecting and mitigating objectionable content (sometimes called contentious content) across multiple online platforms;
   optionally a feature vector construction module 226; and
   optionally a policy specification module 228; and
an optional detection and/or measurement modules 250 that include (as shown in FIG. 2C):
   a user interface module 252 configured to display reports and/or prompts for the users 122-1, . . . , 122-O. In some implementations, the user interface module 208 generates and/or displays criteria 254 for searching the online platforms 244-1, . . . , 244-N. In some implementations, the user interface module 208 provides generic or predefined user profiles to ensure a realistic user experience for the users 122-1, . . . , 122-O, on the online platforms 244-1, . . . , 244-N. In some implementations, the user interface module 208 disguises the users from the online platforms by either providing generic or predefined user profiles, refreshing a browser used by the users for searching the platforms (e.g., refreshing the browser every few minutes), rotating proxies, locations, or other geographic markers, used for browsing by the users, and/or changing protocol used for browsing by the users;
   a contentious content recordation module 256 that records any contentious content 258 tagged by users of the online platforms 244-1, . . . , 244-N. In some implementations, the users (e.g., human scouts) also provide labels 260 for any contentious content, which is obtained and stored by the module 256 for later processing;
   a platform action analysis module 262 that analyses platform actions (e.g., actions taken by the online platforms 244-1, . . . , 244-N) to act on (or react to) any contentious content tagged by the users. The module 262 includes a statistics module 264 for computing and/or storing statistics and/or a platform monitoring module 266 to monitor contents and/or actions taken by the online platforms 244-1, . . . , 244-N, that may include platform-provided APIs and/or modules, or external functions, web applications, or APIs for probing the online platforms;
   a report generation module 268 that generates various reports 270 that indicate contentious content and/or actions taken by the online platforms to purge and/or react to contentious content tagged by the users of the online platforms; and
   an optional synthetic content generation module 272 that generates synthetic contentious or offensive content to upload to the online platforms 244-1, . . . , 244-N, and subsequently monitor how the online platforms react to the synthetic content.

The above identified modules (e.g., data structures, and/or programs including sets of instructions) need not be implemented as separate software programs, procedures, or modules, and thus various subsets of these modules may be combined or otherwise re-arranged in various implementations. In some implementations, memory 202 stores a subset of the modules identified above. In some implementations, a database 240 (e.g., a local database and/or a remote database) stores one or more modules identified above and data associated with the modules. Furthermore, the memory 200 may store additional modules not described above. In some implementations, the modules stored in memory 202, or a non-transitory computer readable storage medium of memory 202, provide instructions for implementing respective operations in the methods described below. In some implementations, some or all of these modules may be implemented with specialized hardware circuits that subsume part or all of the module functionality. One or more of the above identified elements may be executed by one or more of processor(s) 230.

I/O subsystem 234 communicatively couples the system 200 to one or more devices, such as the online platforms (e.g., the platform 244-1, . . . , 244-N, and/or the users 122-1, . . . , 122-O), via a local and/or wide area communications network 242 (e.g., the Internet) via a wired and/or wireless connection. In various implementations, the online platforms 244 host web content (e.g., social media content) that may include objectionable content. In some implementations, some of the operations described herein are performed by the system 200 without any initiation by any of the online platforms 244. For example, the system 200 automatically detects and/or measures objectionable content hosted by any of the online platforms 244. In some implementations, the online platforms 244 submit requests or send requests to the system 200 (e.g., via an application, such as a browser). Communication bus 238 optionally includes circuitry (sometimes called a chipset) that interconnects and controls communications between system components.

Example Methods for Collection of Bad Content from Across the Web

Some implementations retrieve and/or store content from places that exist independently from each other on the Internet. Some implementations perform data collection in a targeted way to aggregate information about specific topics (e.g., specific abuse topics and trends). In various implementations, the data collected includes, but is not limited to, posts and comments shared as text, image, video, audio or 3D data. In some implementations, the targeted collection efforts are initiated with individual pieces of content that are identified through manual investigations, alters and automated monitoring efforts. The data collection methods vary and include crawling, scraping, accessing APIs and direct data sharing agreements. In various implementations, target content is identified using keywords, hashtags, hashes, content matching, account property matching, and/or machine learning algorithms. In some implementations, after data collection, the content is re-formatted to fit a common structure and is stored in a single database. In some implementations, the steps of data collection, formatting, and/or storing of content, is dynamic and is performed on a continuous basis.

### Example Methods for Linking Relevant Content And Metadata

Some implementations retrieve and/or store content metadata from places that exist independently from each other, including information on the content the metadata contextualizes. In various implementations, the data collected includes, but is not limited to, posts and comments shared as text, image, video, audio or 3D data. In some implementations, the data collection is targeted or is specific to specific abuse topics and trends. In some implementations, the collected metadata is linked to relevant content and stored in the same single relational database. Some implementations dynamically generate labels and annotations that link each content (or one or more portions therein) with relevant metadata, thereby allowing dynamic storing and retrieval of corresponding data.

### Example Methods for Social Graph Expansion

Some implementations identify and score strength of relationships between accounts, entities and other groups, across platforms, to construct clusters that relate to the same type of content (e.g., same abuse trend). Some implementations use relationship-based metadata (e.g., account or engagement information) to find common relationships between accounts, groups, content, and/or metadata. For example, such common relationships include social features, such as likes, shares, views, across one or more online media platforms. Some implementations traverse graph-based relationships and numerically score the quality of the network of bad content and accounts, constructing clusters with similar abuse features and risk vectors. Some implementations collect, structure and annotate the information dynamically and allow for real-time querying and data extraction.

### Example Manual Labelling Process

In addition to the fully automated collection, matching, and/or annotation processes described above, some implementations use a manual process to label bad content. By directly combining human and automated labels and scores, some implementations provide unique insights and annotations for consumers of the data. In some implementations, crowd-sourced human moderators apply labels for severity of badness based on an aggregate weighted score that includes manual assessment of absurdity, fairness, inauthenticity, propensity, for harm and other criteria. Some implementations use automated process controls to ensure the quality and consistency of the labeling process. In some implementations, normalized manual labels are subsequently combined algorithmically into a single trust score to label each piece of content. In some implementations, content labels are defined specifically for each abuse vertical and provide consistent risk labels across media formats; languages, and/or products, in each category.

### Example Enforcement Actions by Social Media Companies Based on Trust Scores

In some implementations, scores and/or labels are shared with social media companies, in a batch or through APIs, for specific content snippets, posts and accounts. In some implementations, the scores and labels are shared for entire abuse clusters. In some implementations, the scores and/or labels are used to trigger automated enforcement action, such as removals and generating warning labels. In some implementations, the labels and/or scores serve as a lead source for further investigations.

### Example Method for Detecting Or Mitigating Contentious Multi-Platform Content

FIGS. 3A-3L provide a flowchart of a method 300 for detecting and mitigating contentious multi-platform content. The method executes (302) at a computing system (e.g., the computing system 200 described above in reference to FIG. 2). Typically, the computing system includes a single computer or workstation, or a plurality of computers, each having one or more CPU and/or GPU processors (e.g., the processors 230) and memory (e.g., the memory 202).

The method includes obtaining (304) (e.g., operations performed by the target contents module 208) a plurality of target contents (e.g., the target contents 210) from a plurality of online platforms (e.g., the platforms 244-1, . . . , 244-N) that operate independently from each other. The content may include web pages, web sites, or applications retrieved from online social media platforms, such as Twitter and Reddit, that operate independently from each other. The online platforms may contain at least some similar contentious information.

Referring next to FIG. 3B, in some implementations, obtaining the plurality of target contents includes retrieving and aggregating (312) media content, on a predetermined topic (e.g., specific abuse topics and trends), from the plurality of online platforms. In some implementations, the media content includes (314) multi-media content (e.g., content includes but is not limited to posts and comments shared as text, image, video, audio and 3D formats) shared by users of the plurality of online platforms. In some implementations, the predetermined topic is received (316) from a user (e.g., targeted collection efforts are initiated with individual pieces of content that are identified through manual investigations, alters and automated monitoring efforts).

Referring next to FIG. 3C, in some implementations, obtaining the plurality of target contents includes operations performed on the plurality of online platforms, the operations selected (318) from the group consisting of: crawling, scraping, and accessing APIs and direct sharing agreements. Some implementations use web and image search engines for obtaining the plurality of target contents.

Referring next to FIG. 3D, in some implementations, obtaining the plurality of target contents includes using (320) keywords, hashtags, hashes, content matching, account property matching, or machine learning algorithms (e.g., word or image embeddings and hashes), to identify the plurality of target contents from content posted by users of the plurality of online platforms. In some implementations, obtaining the plurality of target contents includes matching account usernames. In some implementations, any available personally identifiable information (PII), such as full names, phone numbers, e-mails, are also matched.

Referring next to FIG. 3E, in some implementations, obtaining the plurality of target contents includes collecting, reformatting, and storing (322) content, from the plurality of online platforms, to a relational database, continuously on a periodic basis.

Referring back to FIG. 3A, the method also includes identifying (306) contentious content across the plurality of online platforms, by building a knowledge graph (e.g., the knowledge graph 214), based on semantic metadata (e.g., the semantic data 216) extracted from the plurality of target contents. The contentious content identification module 212 performs operations described herein with respect to the step 306, according to some implementations.

Referring next to FIG. 3F, in some implementations, extracting the semantic metadata further includes linking (324) the semantic metadata (e.g., by generating labels and annotations) to relevant content of the plurality of target contents, in a relational database (e.g., for dynamic storing and retrieval of data).

Referring next to FIG. 3G, in some implementations, the semantic metadata includes account and engagement information for users of the plurality of online media platforms. Some implementations use views, shares, likes, and/or comments, for the semantic metadata.

Referring back to FIG. 3A, the method also includes computing (308) strength of relationships between entities (e.g., user accounts, groups), across the plurality of platforms, to construct clusters (e.g., the clusters 218) that relate to the contentious content. The relationship strength computation module 218 performs operations described herein with respect to the step 308, according to some implementations.

Referring next to FIG. 3H, in some implementations, computing the strength of relationships includes identifying and scoring (328) common relationships between accounts, groups, content and the semantic metadata (e.g., social features, such as likes, shares, views, and comments).

Referring next to FIG. 3I, in some implementations, computing the strength of relationships includes traversing (330) a social graph representing the relationships and numerically scoring a quality of the social graph for any contentious content and accounts, thereby constructing the clusters with similar abuse features or risk vectors.

Referring next to FIG. 3J, in some implementations, the method further includes: obtaining (332), from one or more users (e.g., crowdsourced human moderators), one or more labels indicating severity of badness for the plurality of target contents; and constructing (340) the clusters that relate to the contentious content further based on the one or more labels. In some implementations, the method further includes selecting (342) a set of labels from the one or more labels based on determining quality and consistency of the one or more labels, and constructing the clusters is further based on the set of labels. In some implementations, the one or more labels are combined (334) algorithmically into a single trust score to label each content of the plurality of target contents. In some implementations, the one or more labels are defined (334) specifically for each abuse category. In some implementations, the one or more labels provide (338) consistent risk labels across media formats, languages and products, in each abuse category

Referring back to FIG. 3A, the method also includes triggering (310) an enforcement action corresponding to the contentious content, for a target online platform, based on the clusters. The enforcement module 222 performs operations described herein with respect to the step 310, according to some implementations. Referring next to FIG. 3K, in some implementations, the method further includes providing (344) one or more APIs for the target online platform, to access at least a portion of the contentious content (e.g., specific content snippets, posts and accounts) or the cluster, the one or more APIs configured to trigger the enforcement action. Referring next to FIG. 3L, in some implementations, the enforcement action includes (346) one or more operations selected from the group consisting of: removal of the contentious content from the target online platform, generating one or more warnings for the contentious content, and generating an alert for a user to examine the contentious content.

### Example Method for Training Machine Learning Classifiers

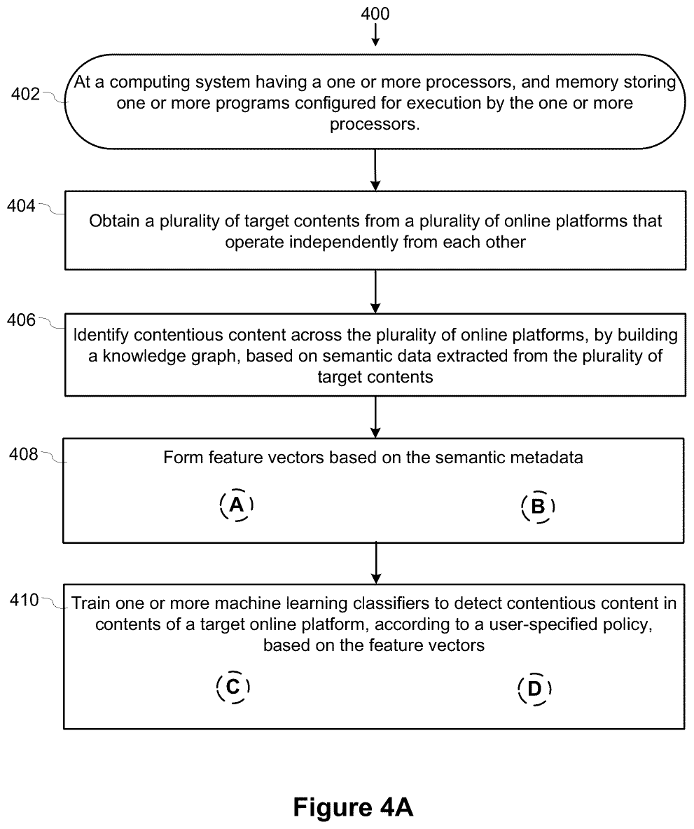

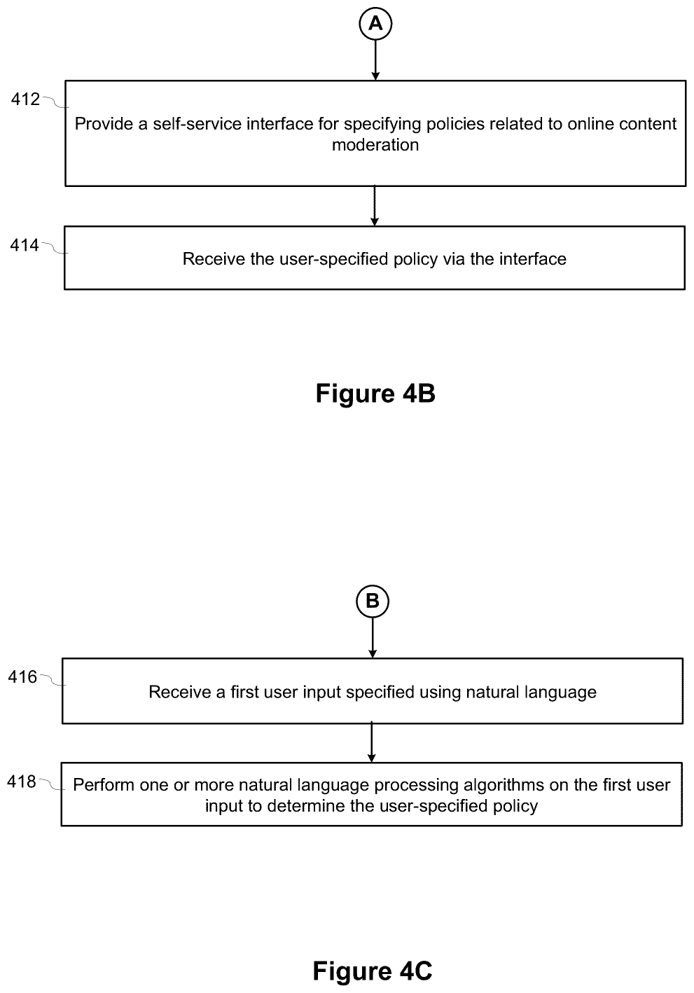

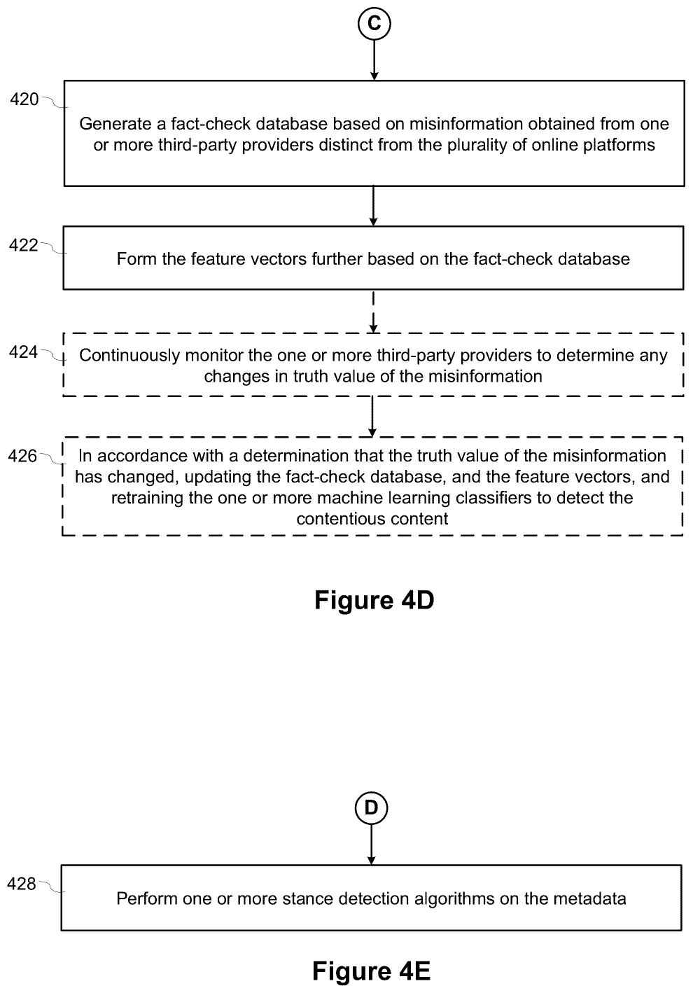

FIGS. 4A-4E provide a flowchart of a method 400 for training machine learning classifiers for detecting contentious multi-platform content. The method executes (402) at a computing system (e.g., the computing system 400). Typically, the computing system includes a single computer or workstation, or a plurality of computers, each having one or more CPU and/or GPU processors and memory.

The method includes obtaining (404) (e.g., using the target contents module 308) a plurality of target contents from a plurality of online platforms that operate independently from each other. The method also includes identifying (406) (e.g., using the contentious content identification module 212) contentious content across the plurality of online platforms, by building a knowledge graph, based on semantic metadata extracted from the plurality of target contents.

Referring next to FIG. 4B, in some implementations, the method further includes providing (412) a self-service interface (e.g., via the policy specification module 228 and/or the display 236) for specifying policies related to online content moderation, and receiving (414) the user-specified policy via the interface. Referring next to FIG. 4C, in some implementations, the method further includes receiving (416) a first user input specified using natural language; and performing (418) one or more natural language processing algorithms on the first user input to determine the user-specified policy. In some implementations, the method further includes displaying one or more outputs to further ascertain information in the first user input; and, in response to a second user input to either confirm or deny the information, refining the first user input, prior to performing the one or more natural language processing algorithms.

In some implementations, a client (sometimes called a user) uploads their content type (e.g., text, image, video) and their policy (e.g., a policy stated in natural language, such as English) to a self-service policy classifier. An example policy is “Nudity is not allowed except in documentary context.” In some implementations, the system prompts the user that their uploaded policy will be checked, and that they will get a notification later. In some implementations, the system routes the policy as an instruction to a crowd, and asks the crowd to rate a set of content (e.g., images). Once the crowd has finished rating the content, the system notifies the client to check the ratings on the set of content. If the client indicates that the client is mostly in agreement with the ratings from the crowd, the system proceeds to subsequent steps. Otherwise, the system either notifies the client that the given policy is not supported at this time, or attempts to perform one or more interactions. For example, some implementations asks the client to clarify the policy language, and/or to more clearly explain why the ratings are incorrect. Some implementations repeat the steps described above using the updated policy language, to further refine the policy.

Some implementations provide structured options to construct the policy. In some implementations, the structured options are provided in addition to the self-service policy classifier (or interface) described above. In some implementations, the structured options are provided instead of the self-service policy classifier described above. For example, the system may ask the client to indicate which of the following is their preferred policy as it pertains to profanity in a video context: (a) profanity, such as four letter words, is not allowed in any context, (b) profanity is permitted in documentary contexts only, or (c) profanity is permitted in documentary contexts as well as when tastefully done or involving high production values, such as content seen on cable television.

After the system determines the policy, some implementations determines an acceptable metric to measure a quality of service in terms of whether the policy is being correctly enforced. Some implementations use precision and recall for this purpose. Some implementations determine how high precision/recall can be achieved depending on how ambiguous the policy is. In the example described above, for the structured case, the system already knows what precision/recall tradeoffs are possible, because the classifiers corresponding to the options being provided to the client are predetermined and evaluated. In the case of the unstructured option, the system determines, based on agreement levels in the crowd ratings for the sample content (e.g., the images), what precision/recall is feasible, and the system notifies the client of the same. Some implementations provide the client the ability to tradeoff precision for recall or vice-versa. For example, default tuning of precision/recall could achieve a value of 60/60, but the client may choose higher recall or higher precision, and the system changes the metric to 40/80 or 80/40, accordingly.

Referring back to FIG. 4A, the method also includes forming (408) feature vectors (e.g., using the feature vector construction module 226) based on the semantic metadata, and training (410) one or more machine learning classifiers (e.g., steps performed by the machine learning classifiers 224) to detect contentious content in contents of a target online platform, according to a user-specified policy, based on the feature vectors. Referring next to FIG. 4D, in some implementations, the method further includes generating (420) a fact-check database (e.g., data stored in the database 240) based on misinformation obtained from one or more third-party providers (e.g., the third-party providers 246-1, . . . , 246-M) distinct from the plurality of online platforms; and forming (422) the feature vectors further based on the fact-check database. In some implementations, the method further includes: continuously monitoring (424) the one or more third-party providers to determine any changes in truth value of the misinformation; and, in accordance with a determination that the truth value of the misinformation has changed, updating the fact-check database, and the feature vectors, and retraining (426) the one or more machine learning classifiers to detect the contentious content. Referring next to FIG. 4E, in some implementations, forming the feature vectors includes performing one or more stance detection algorithms on the metadata.

### Example Method for Detecting and Mitigating Contentious Multi-Platform Content Using Machine Learning Classifiers

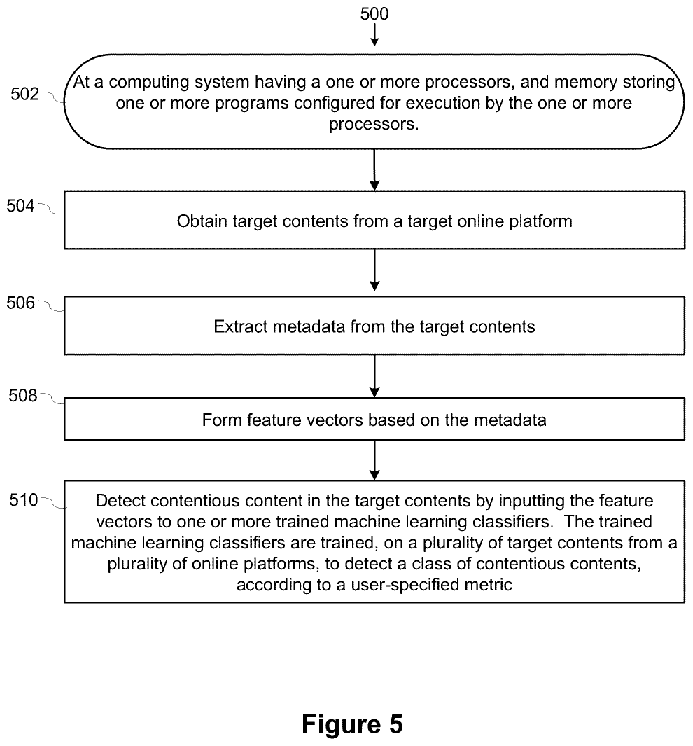

FIG. 5 provides a flowchart of a method 500 for detecting and mitigating contentious multi-platform content. The method is performed (502) at a computing system (e.g., the computing system 200) having one or more processors (the processors 230), and memory (e.g., the memory 202) storing one or more programs configured for execution by the one or more processors. The method includes obtaining (504) target contents from a target online platform (e.g., any of the online platforms 244-1, . . . , 244-N). The method also includes extracting (506) metadata from the target contents. The method also includes forming (508) feature vectors (e.g., using the feature vector construction module 226) based on the metadata, and detecting (510) contentious content in the target contents by inputting the feature vectors to one or more trained machine learning classifiers (e.g., the classifiers trained as described above in reference to FIGS. 4A-4E). The trained machine learning classifiers are trained, on a plurality of target contents from a plurality of online platforms (e.g., the online platforms 244-1, . . . , 244-N), to detect a class of contentious contents, according to a user-specified metric.

### Example Content Safety Risk Monitoring

It is impossible to manage what cannot be measured. So some implementations measure the amount or extent of bad content on a given platform. Subsequently, the system 200 determines if existing enforcement operations are effective. Various implementations measure the ease with which bad content is found, industry performance (for detecting and/or removing the bad content), user's perception of content, and/or if policy is appropriate. Such unbiased third party measurement builds trust with regulators, media, and the general public. Some implementations determine intent of social media user content or social media user actions, via an active search, searching for bad user content and/or accounts. Some implementations use findability rates, algorithmic recommendations (feeds), and/or platform response monitoring, as metrics. Some implementations measure what content is recommended to a user in a feed, using both a holdout set (e.g., a set that has no particular bias or purpose) and a testing set (e.g., a set that looks for a particular badness), and train the feed based on the measurements. By comparing the severity of content between the two sets on a particular topic, some implementations determine an extent to which the feed recommends severe content. If the content recommended is more severe than the content used to train the algorithm (a situation that is sometimes called amplification), some implementations modify (e.g., de-radicalize) the recommended content to a normal severity (or a predetermined level of severity). If the content recommended is about the same severity as (or is less severe than) the content used to train the algorithm, some implementations allow or continue the recommended content. Some implementations measure what content recommended causes echo chamber or filter bubble effects, on a given platform.

Some implementations measure exposure via a passive search, measure stratified impression, and/or perform weighted sampling. Some implementations detect and mitigate exposure to bad content through user surveys and complaints, and/or user sentiment analysis.

### Example Types of Content Safety Metrics

For content safety metrics, various implementations of the system 200 use actionable leads and examples, industry benchmarks, ease of deployment with or without integration (to hosting platform), provision of dashboard with thresholds and benchmarks, independent and trusted third party assessment, flexibility across verticals, languages, demographics and competitors.

### Example Measurement Project

A pilot study was performed for specific abuse verticals and specific demographics. The pilot study was used to define difference between user perception and policy standards, statistically sound findability rates for bad content and behavior, performance metrics for enforcement response, real-time dashboards and industry comparisons. Some implementations measure detection and mitigation across social media platforms, measure benchmark content badness at scale across verticals. Some implementations provide actionable insights that help online platforms remove objectionable content.

### Example Bad Content Scouting

In some implementations, the users (sometimes called scouts, e.g., human scouts, bots, or algorithms) search for bad content in a specific vertical for a predefined period of time and their findings are documented. Each individual search session is limited to a platform, product or otherwise pre-defined space online. Instructions for how to search can be prescriptive including specific text, images or other media snippets, or a general problem description of abuse behavior or entities or bad actors. Instructions can also be much broader and leave much or even all of the control for how to find bad content to the scouts. In some implementations, a tool records and analyzes the search process of scouts, takes screen shots and tags the bad content they find. The entire process is performed hidden from the platform using generic or otherwise predefined user profiles to ensure a realistic user experience. The scouting process is repeated with all participating platforms.

### Example Content Labeling for Severity

In some implementations, crowd-sourced or in-house human moderators apply labels for severity of badness on the flagged content (e.g., misinformation) based on an aggregate weighted score that includes humanly assessed absurdity, fairness, inauthenticity, propensity for harm and other criteria. In some implementations, automated and process controls are in place to ensure the quality and consistency of the labeling process. In some implementations, normalized manual labels are then combined algorithmically into a single trust score to label each piece of content for severity. In some implementations, content labels are defined specifically for each abuse vertical and provide consistent risk labels across media formats, languages and products in each abuse category.

### Example Content Uploads

Some implementations enable the upload of content with specific properties using generic or otherwise pre-defined user profiles to various platforms simultaneously to measure their response. Specifically assigned or custom-created content in the form of text, image or other media formats is automatically saved on the platform as public facing user generated content.

### Example Flagging of Content to Online Platform

In some implementations, content that scouts identify as problematic and that is subsequently labeled with a minimum severity score, are flagged, to the platform that hosts the content, as problematic using the platform's existing on-platform complaints mechanisms. In some implementations, the entire process is performed using generic user profiles to ensure a realistic user experience. In some implementations, the system then tracks via pings and content analysis when and how the status of the content on the platform changes. In some instances, the content may get removed, a warning label may be added or replaced with other content, for example. In some implementations, the system then documents the status in a database as well as when the change occurred.

### Example Aggregation of Results

In some implementations, collected information is quality checked, structured consistently and combined in a single database for comprehensive analysis using scientific statistical methods. In some implementations, findings are reported in customized formats based on reporting needs of clients. In addition to directly observed findings, some implementations compute a number of novel statistical insights, including the public perception of content to objectively benchmark policy severity against user expectations and industry standards.

### Example Misinformation Report

Example reports are described herein to illustrate the reporting capabilities of the system according to some implementations. In one experiment, sixty popular fact-checked false claims that were reviewed by reputable organizations, such as Snopes, BBC and Reuters, were used. These stories were divided into four topic areas that represent misinformation broadly (e.g., topics related to COVID, Elections, Black Lives Matter and QAnon).

Operators and the system spent 400 hours scouting for misinformation content related to these fact-checked stories. The scouting was performed by humans and additional validation and tracking were performed with the system's internal tools. Each expert scout performed a one hour search per platform for every story they were randomly assigned to. The experimental study covered six leading social media platforms, including Facebook, TikTok, YouTube, Twitter, Instagram and Pinterest. Every piece of content that was found by the scouts was also flagged to the platforms as a user complaint.

All data was quality checked by manual and automated measurement processes. The analysis relied on statistically significant findings, which were also cross-checked by multiple team members.

The results were reported under several metrics, including findability (ease for a susceptible user to find bad content in a specific vertical), speed of response (time to remove reported and unreported bad content), enforcement strictness (content policy compared to user expectations and other platforms), and proactive defenses (effectiveness of platform defenses at removing unreported bad content).

### Example Method for Detecting and Measuring Objectionable Multi-Platform Content

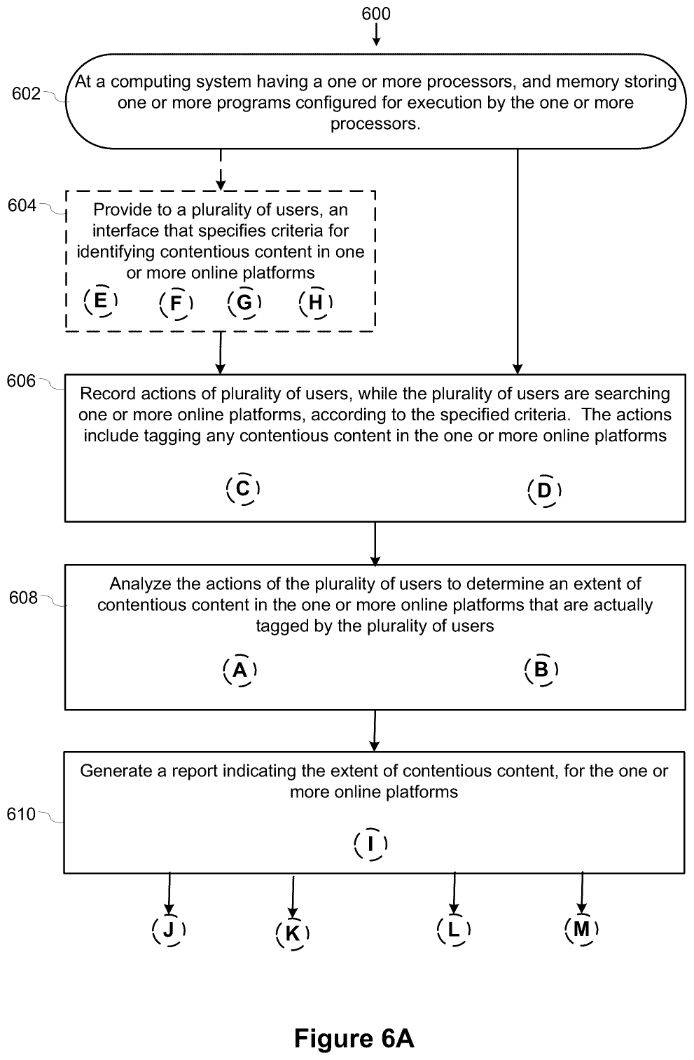

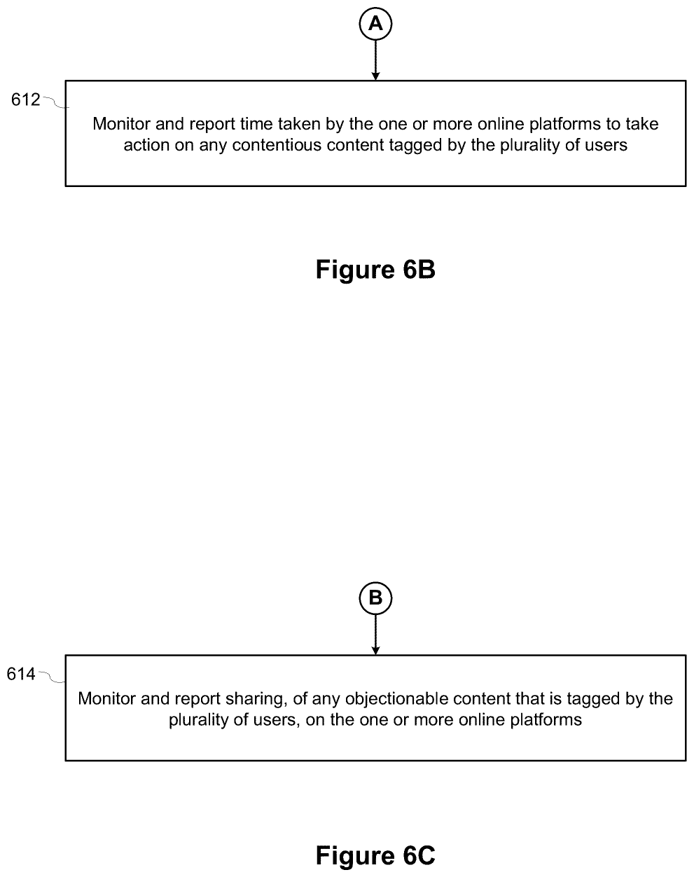

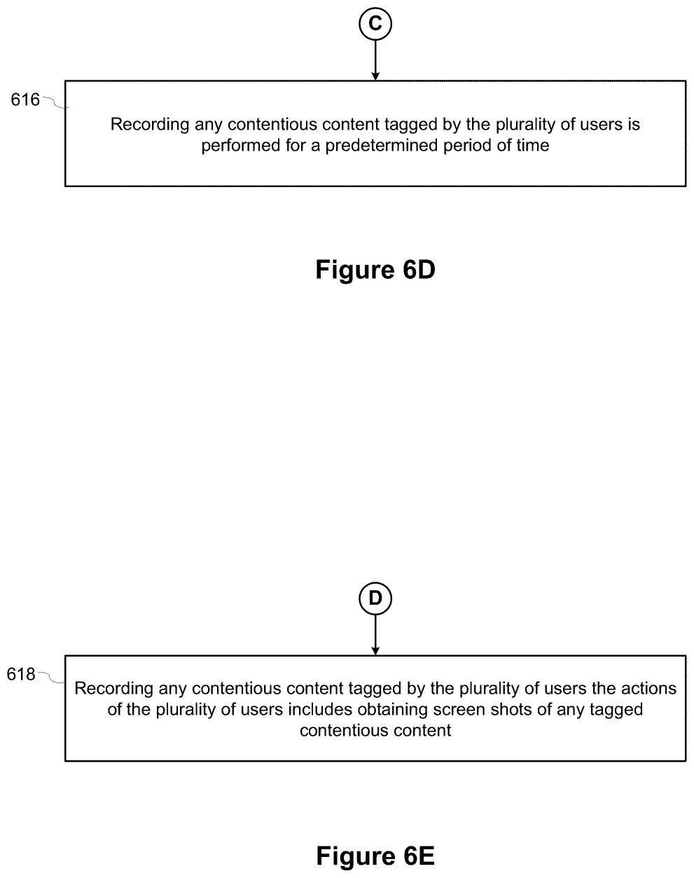

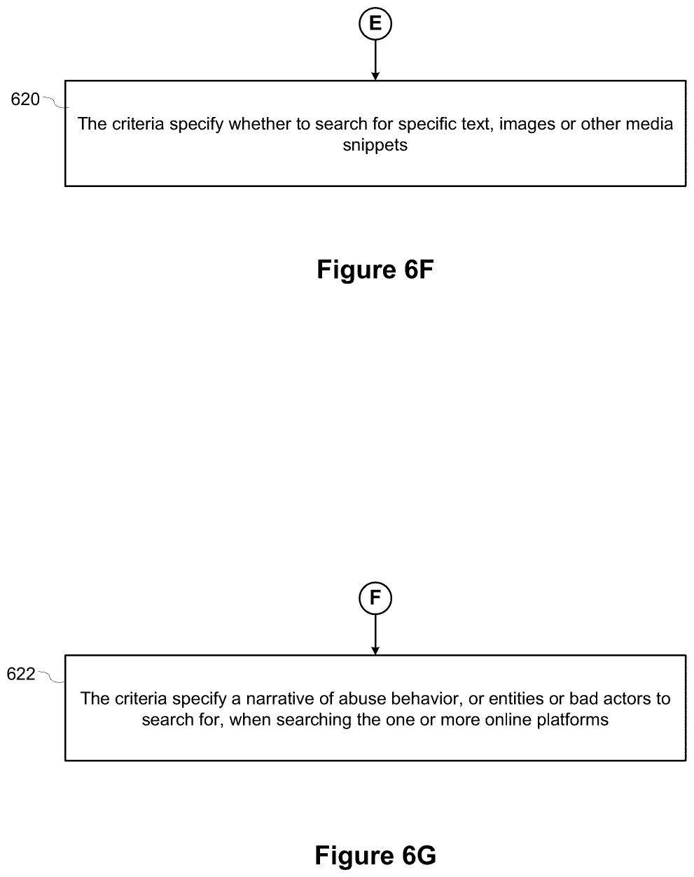

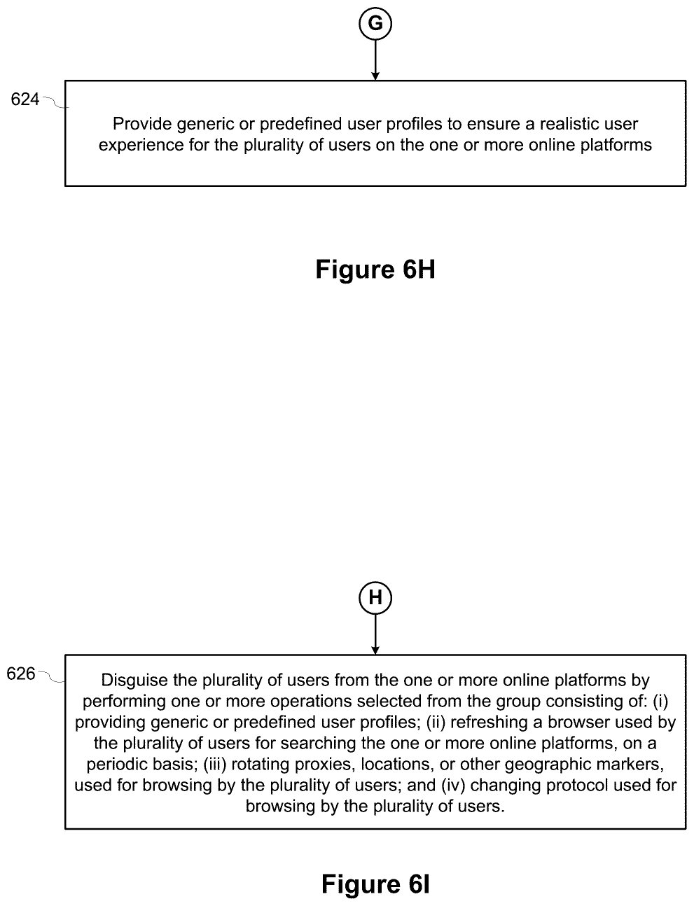

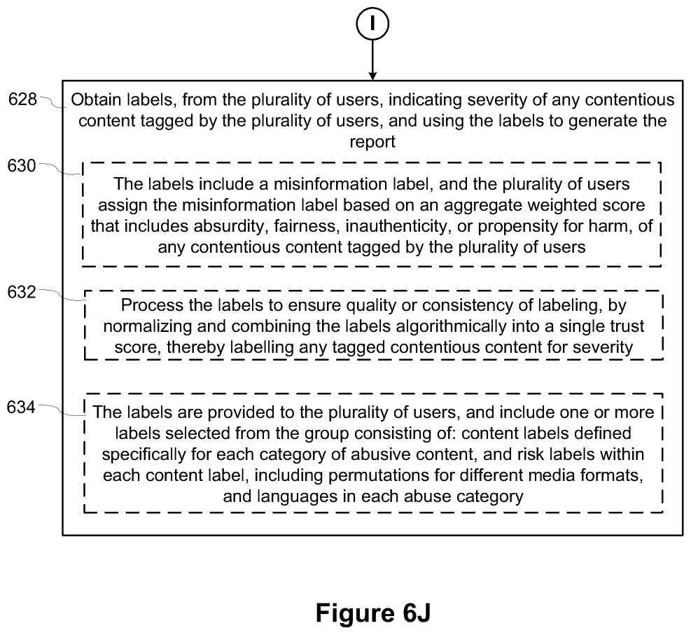

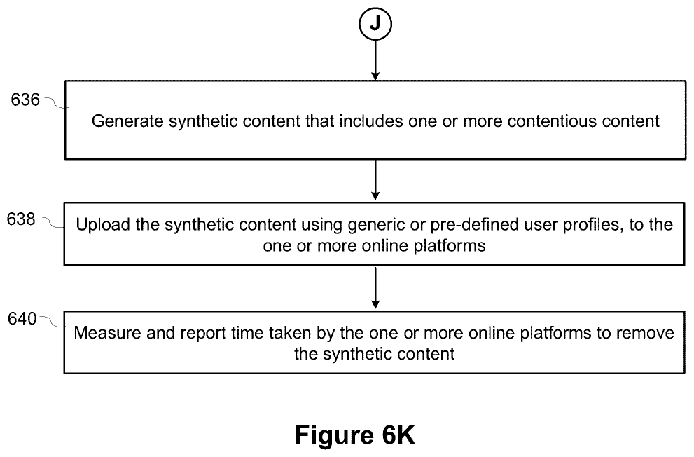

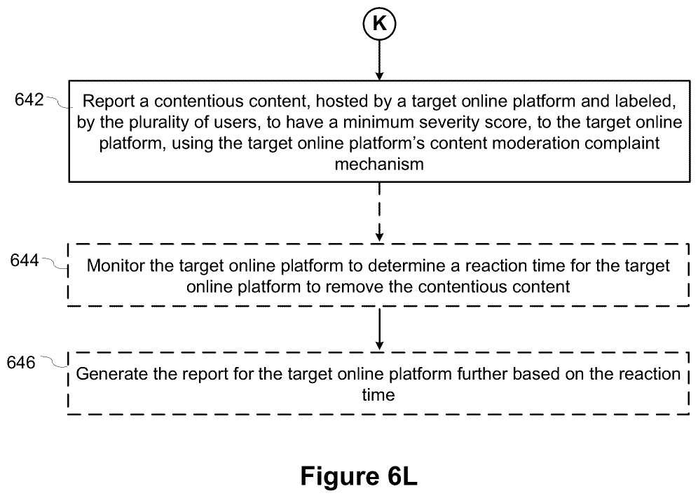

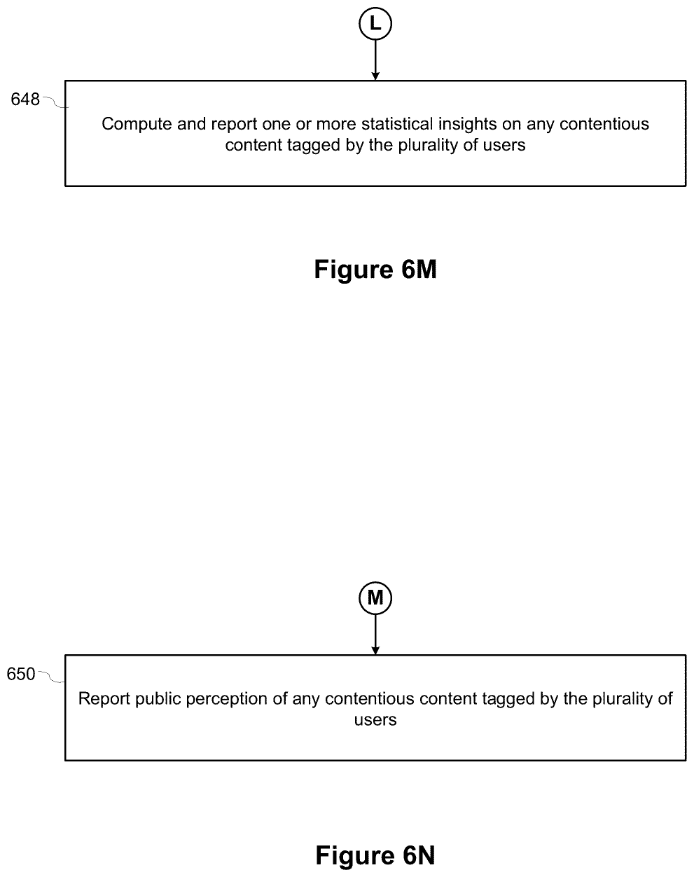

FIGS. 6A-6N show a flowchart for an example method 600 for detecting and measuring objectionable multi-platform content executes (602) at a computing system, according to some implementations. Typically, the computing system (e.g., the system 200) includes a single computer or workstation, or plurality of computers, each having one or more processors the processors 230, such as CPU and/or GPU processors) and memory (e.g., the memory 202).

In some implementations, the method includes providing (604), to a plurality of users (e.g., the users 122-1, . . . , 122-O), an interface (e.g., using the user interface module 252) that specifies criteria (e.g., the criteria 254) for identifying contentious content in one or more online platforms. Referring next to FIG. 6F, in some implementations, the criteria specify (620) whether to search for specific text, images or other media snippets. Referring next to FIG. 6G, in some implementations, the criteria specify (622) a narrative of abuse behavior, or entities or bad actors to search for, when searching the one or more online platforms. Referring next to FIG. 6H, in some implementations, the method further includes providing (624) generic or predefined user profiles to ensure a realistic user experience for the plurality of users on the one or more online platforms. Referring next to FIG. 6I, in some implementations, the method further includes disguising (626) the plurality of users from the one or more online platforms by performing one or more operations selected from the group consisting of: providing generic or predefined user profiles; refreshing a browser used by the plurality of users for searching the one or more online platforms, on a periodic basis; rotating proxies, locations, or other geographic markers, used for browsing by the plurality of users; and changing protocol used for browsing by the plurality of users.

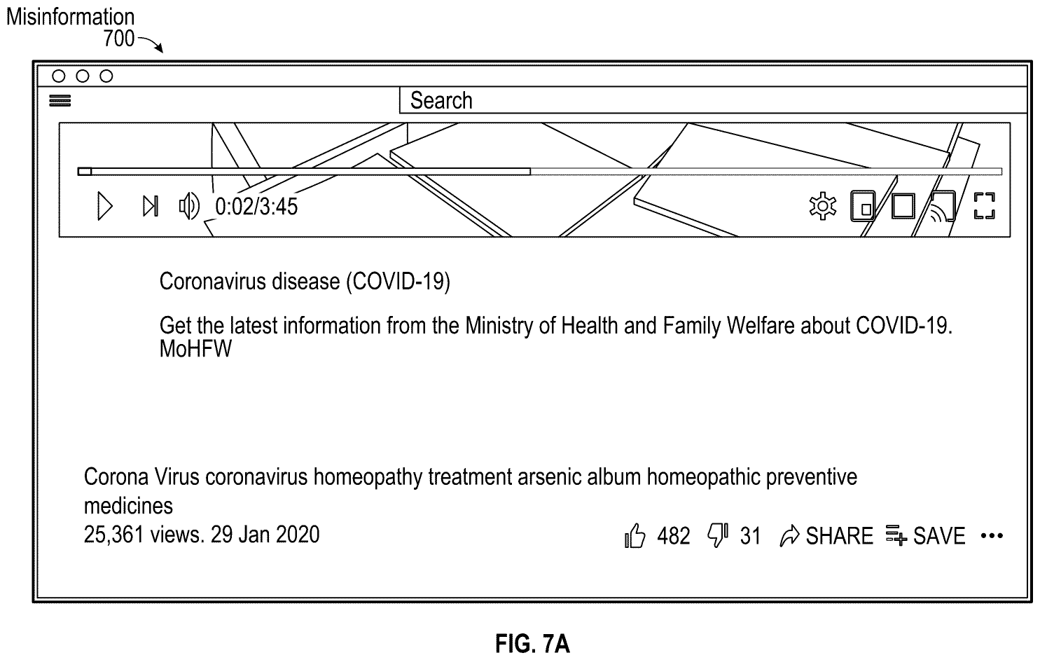

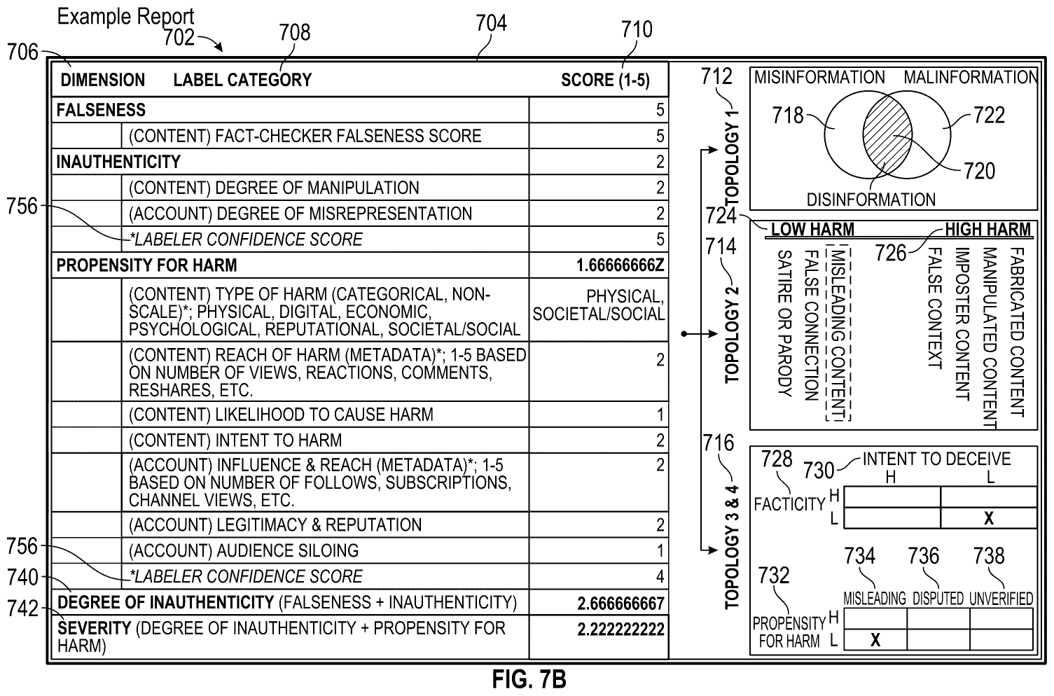

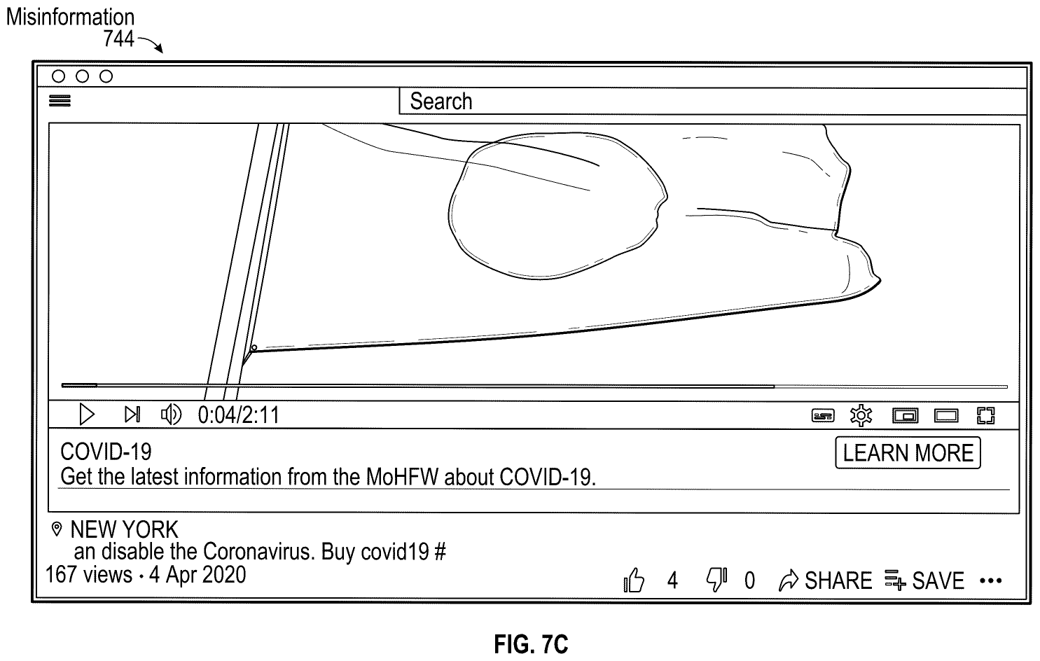

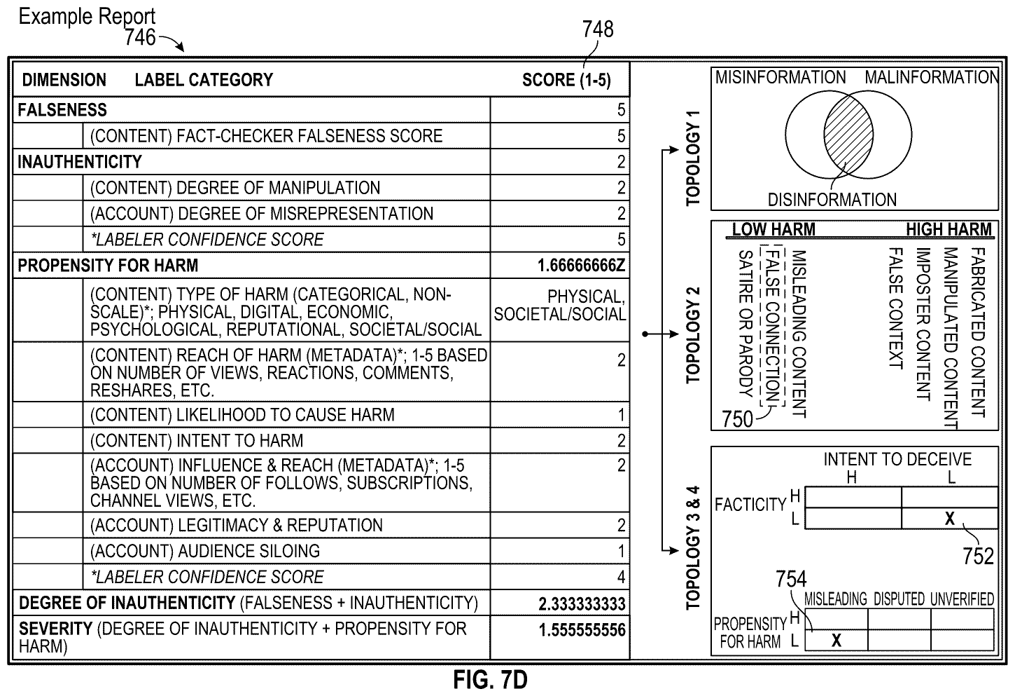

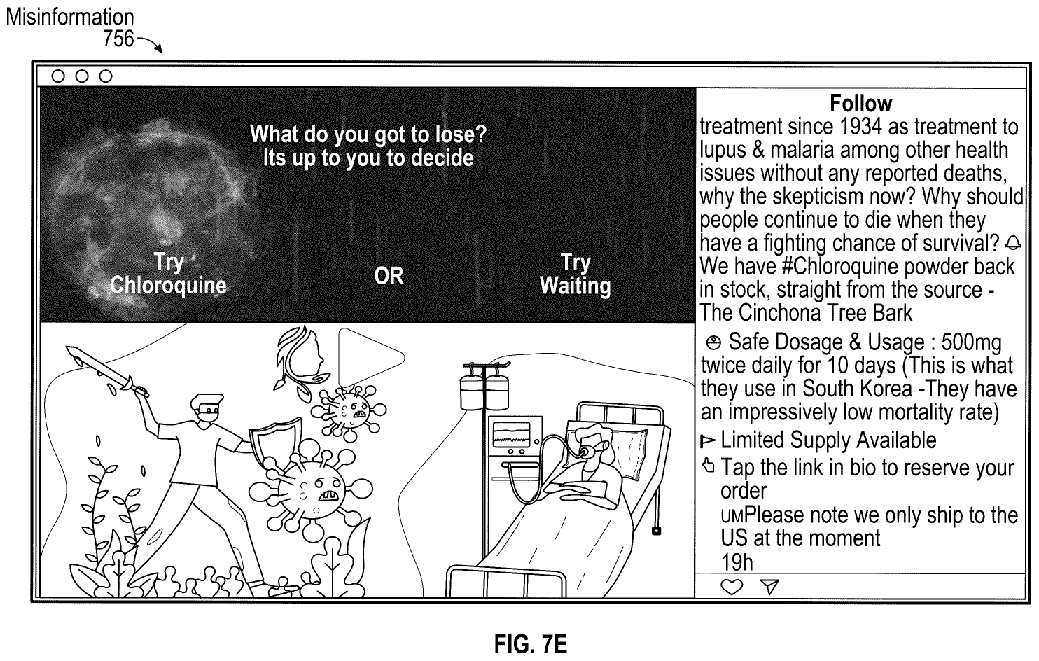

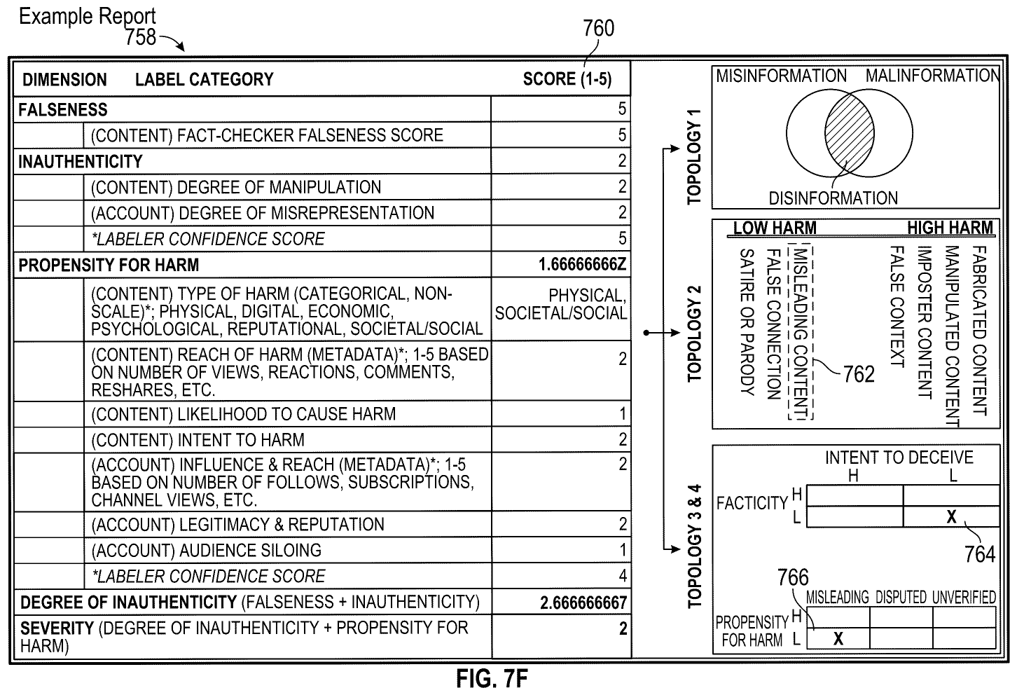

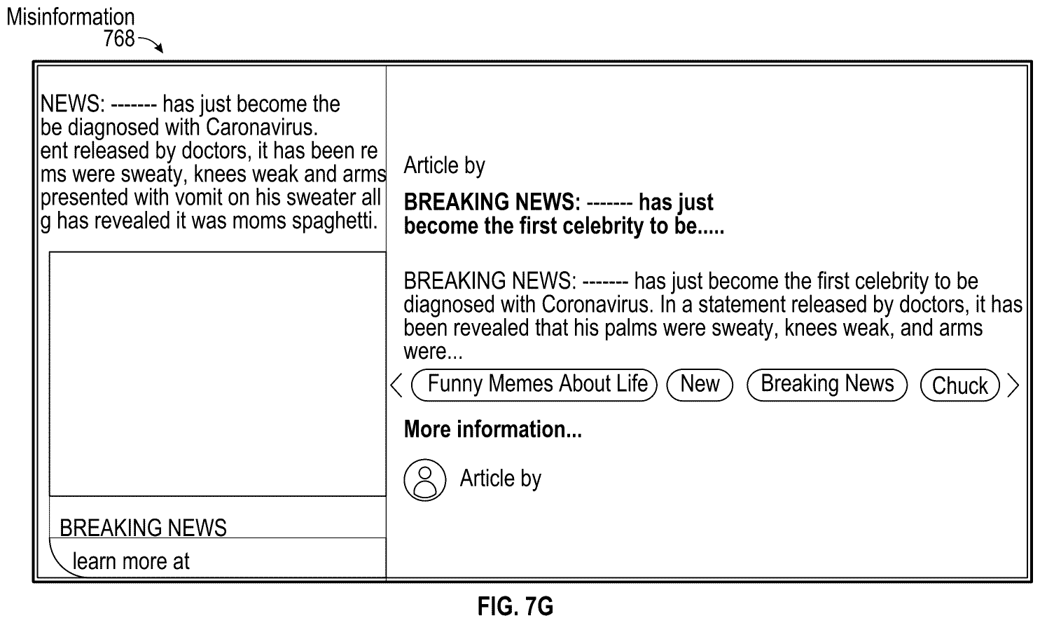

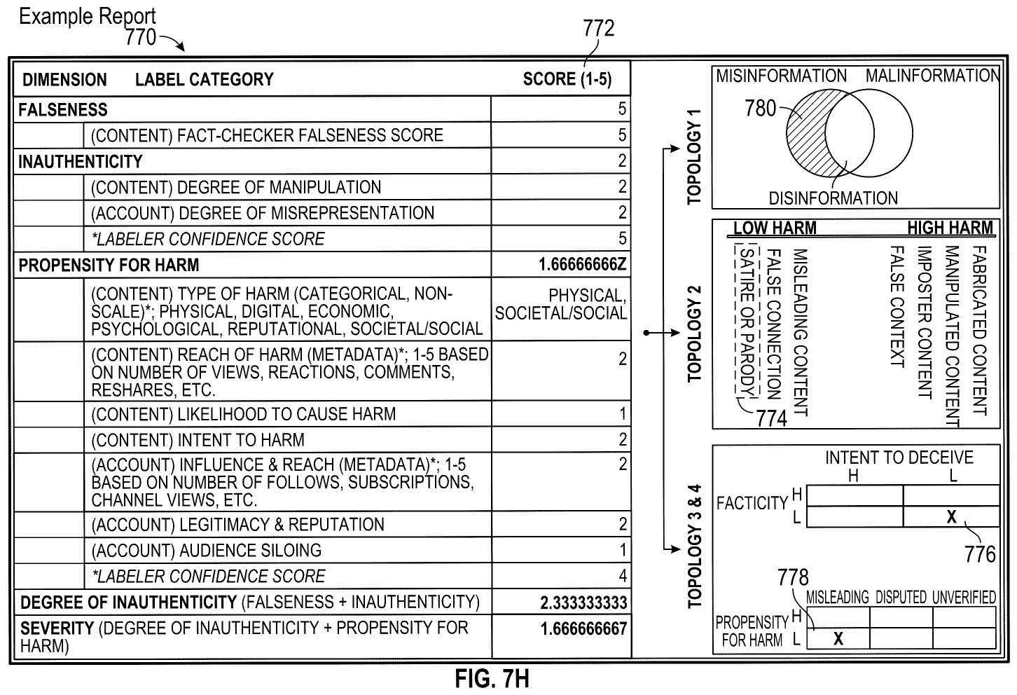

Referring back to FIG. 6A, the method includes recording (606) (e.g., using the module 256) any contentious content (e.g., the content 258) in the one or more online platforms tagged by the plurality of users, while the plurality of users are searching the one or more online platforms according to the specified criteria. Referring next to FIG. 6D, in some implementations, recording any contentious content tagged by the plurality of users is performed (616) for a predetermined period of time (e.g., an hour, an entire day). Referring next to FIG. 6E, in some implementations, recording any contentious content tagged by the plurality of users includes obtaining (618) screen shots of any tagged contentious content, examples of which are shown in FIGS. 7A, 7C, 7E, and 7G.

Referring back to FIG. 6A, the method also includes analyzing (608) actions (e.g., using the platform action analysis module 262) of the one or more online platforms to determine an extent of contentious content tagged by the plurality of users. Referring next to FIG. 6B, analyzing actions of the one or more online platforms includes monitoring and reporting (612) time taken by the one or more online platforms to take action on any contentious content tagged by the plurality of users. Referring next to FIG. 6C, analyzing actions of the one or more online platforms includes monitoring and reporting (614) sharing (e.g., using the report generation module 268), of any objectionable content that is tagged by the plurality of users, on the one or more online platforms.

Referring back to FIG. 6A, the method also includes generating (610) a report (e.g., using the report generation module 268) indicating the extent of contentious content, for the one or more online platforms.

Referring next to FIG. 6J, in some implementations, the method further includes obtaining (628) labels (e.g., the labels 260), from the plurality of users, indicating severity of any contentious content tagged by the plurality of users, and using the labels to generate the report. In some implementations, the labels include (630) a misinformation label, and the plurality of users assign the misinformation label based on an aggregate weighted score that includes absurdity, fairness, inauthenticity, or propensity for harm, of any contentious content tagged by the plurality of users. In some implementations, the method further includes processing (632) the labels to ensure quality or consistency of labeling, by normalizing and combining the labels algorithmically into a single trust score, thereby labelling any tagged contentious content for severity. In some implementations, the labels are provided (634) to the plurality of users, and include one or more labels selected from the group consisting of: content labels defined specifically for each category of abusive content, and risk labels within each content label, including permutations for different media formats, and languages in each abuse category.

Examples of disinformation, misinformation, and mal-information, and associated handling, processing, and/or reporting such content, are described here in reference to FIGS. 7A-7H, according to some implementations. In FIG. 7A, the system 200 detects misinformation 700 tagged by a user (e.g., a human scout or a bot). The misinformation 700 relates to a purported treatment for coronavirus disease (COVID-19). Some implementations obtain a screenshot or a snapshot of the content, and store such content, for further processing, and/or reports back to the online platform that hosts the content. FIG. 7B shows an example report 702 generated for the content shown in FIG. 7A, according to some implementations. In this example, a table 704 is generated and shows dimensions 706 (e.g., falseness, inauthenticity, propensity for harm), label category 708 for each dimension, and score 710 (e.g., a value between 1-5) for each category. Also shown is a degree of inauthenticity 740 (including falseness and inauthenticity), and a severity 742 (including degree of inauthenticity and propensity for harm), as numerical scores. As shown, some implementations provide topological information shown on the tight hand side of the report 702. For example, as shown, a first topology 712 shows classification of the content as either misinformation 718, disinformation 720, or mal-information 722. A second topology 714 classifies the content as either low harm 724 (e.g., either satire or parody, false connection, or misleading content), or high harm 726 (e.g., either false content, imposter content, manipulated content, or fabricated content). And another set of topologies 716 classifies the content on the basis of facticity 728 (high or low threshold) and intent to deceive 730 (high or low threshold), and on the basis of propensity for harm 732 and either misleading 734, disputed 736 or unverified 738. In this example, the content is classified as disinformation, low harm (misleading content), low intent to deceive, low facticity, low propensity to harm, and misleading. Some implementations allow the user (e.g., human scouts searching the online platforms) to label the contents, assign scores, and/or specify a confidence score (e.g., confidence scores 756) for the scoring and/or labelling. Some implementations use machine learning and/or natural language processing techniques for the scoring and/or categorization. Some implementations perform classification of abusive content using machine learning and/or language processing techniques. For example, at a high level, some implementations extract features from the content (e.g., content with text and images) using off-the-shelf machine learning, artificial intelligence, or natural language processing software. Some implementations segment data into training and validation sets, using labeled content (e.g., content labeled by humans) as ground truth. Some implementations select features, based on their efficacy in predicting the ground truth outcomes on the training set, before applying the same selection or weighting to the validation set to evaluate a machine learning model. When the model achieves necessary performance (e.g., prediction accuracy reaches a predetermined or input threshold accuracy), the model is then deployed to replace or augment the human labeling or search processes.

FIG. 7C shows another example of misinformation 744 tagged by users (or detected by the system 200), according to some implementations. The example is an advertisement for buying a drug for COVID-19. FIG. 7D shows an example report 742 generated for the content shown in FIG. 7C, according to some implementations. The example shows different scores 748, noticeably higher values for falseness, and therefore categorization as false content 750, low facticity and low intent to deceive (as indicated by mark 752), and low propensity for harm and disputed content (as indicated by mark 754).

FIG. 7E shows another example of misinformation 756 tagged by users (or detected by the system 200), according to some implementations. The example is an advertisement for trying chloroquine or trying waiting (for COVID-19). FIG. 7F shows an example report 758 generated for the content shown in FIG. 7E, according to some implementations. The example shows different scores 760, noticeably higher values for falseness, and therefore categorization as misleading content 762, low facticity and low intent to deceive (as indicated by mark 764), and low propensity for harm and disputed content (as indicated by mark 766).

FIG. 7G shows another example of misinformation 768 tagged by users (or detected by the system 200), according to some implementations. The example is a breaking news regarding a first celebrity who is purportedly diagnosed with coronavirus. FIG. 7H shows an example report 770 generated for the content shown in FIG. 7G, according to some implementations. The example shows different scores 772, and categorization as misinformation 780 (unlike the previous examples), satire or parody 774, low facticity and low intent to deceive (as indicated by mark 776), and low propensity for harm and misleading content (as indicated by mark 778).

Referring now back to FIG. 6K, in some implementations, the method further includes generating (636) synthetic content that includes one or more contentious content, uploading (638) the synthetic content (e.g., using the synthetic content generation module 272) using generic or pre-defined user profiles, to the one or more online platforms, and measuring and reporting (640) time taken by the one or more online platforms to remove the synthetic content.

Referring next to FIG. 6L, in some implementations, the method further includes reporting (642) a contentious content, hosted by a target online platform and labeled, by the plurality of users, to have a minimum severity score, to the target online platform, using the target online platform's content moderation complaint mechanism. In some implementations, monitoring (644) the target online platform to determine a reaction time for the target online platform to remove the contentious content; and generating (646) the report for the target online platform further based on the reaction time.

Referring next to FIG. 6M, in some implementations, the method further includes computing and reporting (648) one or more statistical insights (e.g., using the statistics module 264) on any contentious content tagged by the plurality of users.

Referring next to FIG. 6N, in some implementations, the method further includes reporting (650) public perception of any contentious content tagged by the plurality of users so as to benchmark policy severity against user expectations and industry standards.

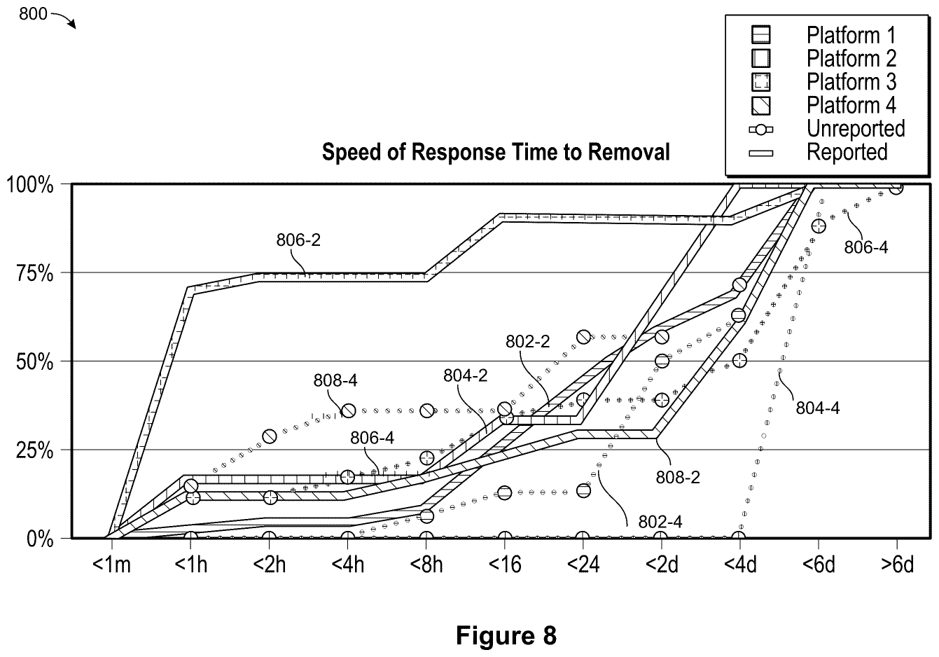

FIG. 8 shows an example visualization 800 of speed of response (e.g., time to removal) for platforms, according to some implementations. The visualization is a graph plot of percentage of removal (after objectionable content is reported) to an online platform over time (in minutes, hours, and days). Lines 802-2, 804-2, 806-2, and 808-2 correspond to speed of response for removing reported content, for platforms 1, 2, 3, and 4, respectively, and lines 802-4, 804-4, 806-4, and 808-4 correspond to speed of response for removing unreported content, for platforms 1, 2, 3, and 4, respectively. As illustrated, different platforms have different response times, different rate of removal, and different response time and removal rate for unreported contents and reported contents.

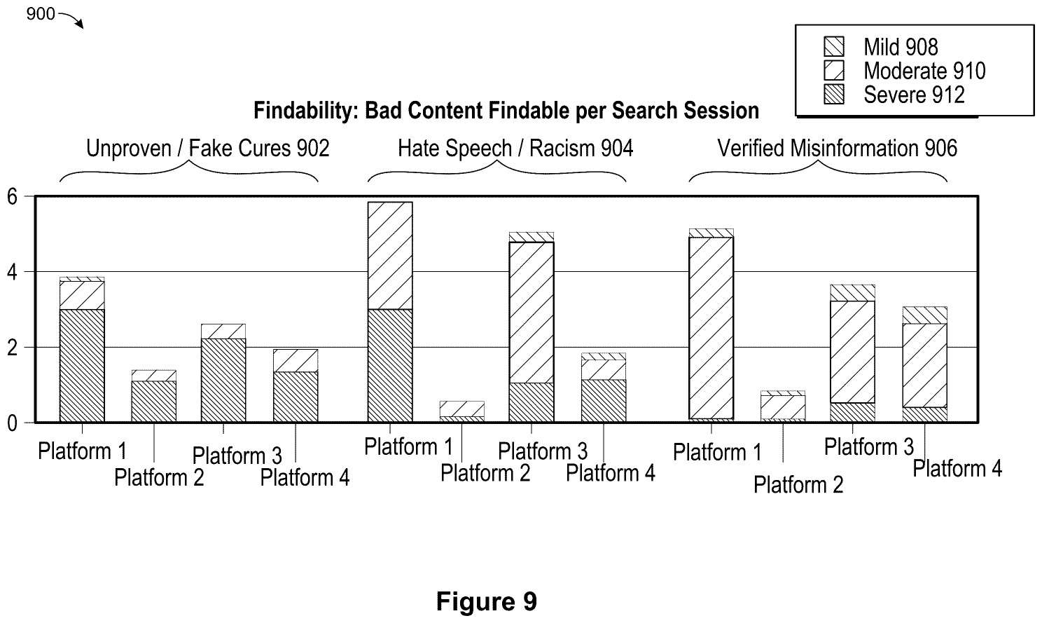

FIG. 9 shows an example visualization 900 of findability of bad content, according to some implementations. FIG. 9 shows bad content findable per search session for the platforms 1, 2, 3, and 4, shown in FIG. 8, categorized as unproven or fake cures 902, hate speech or racism 904, and verified misinformation 906, further categorized as mild 908, moderate 910, and severe 912, for each platform. The visualization is a graph plot of percentage of removal (after objectionable content is reported) to an online platform over time (in minutes, hours, and days). Lines 802-2, 804-2, 806-2, and 808-2 correspond to speed of response for removing reported content, for platforms 1, 2, 3, and 4, respectively, and lines 802-4, 804-4, 806-4, and 808-4 correspond to speed of response for removing unreported content, for platforms 1, 2, 3, and 4, respectively. As illustrated, different platforms have different response times, different rate of removal, and different response time and removal rate for unreported contents and reported contents.

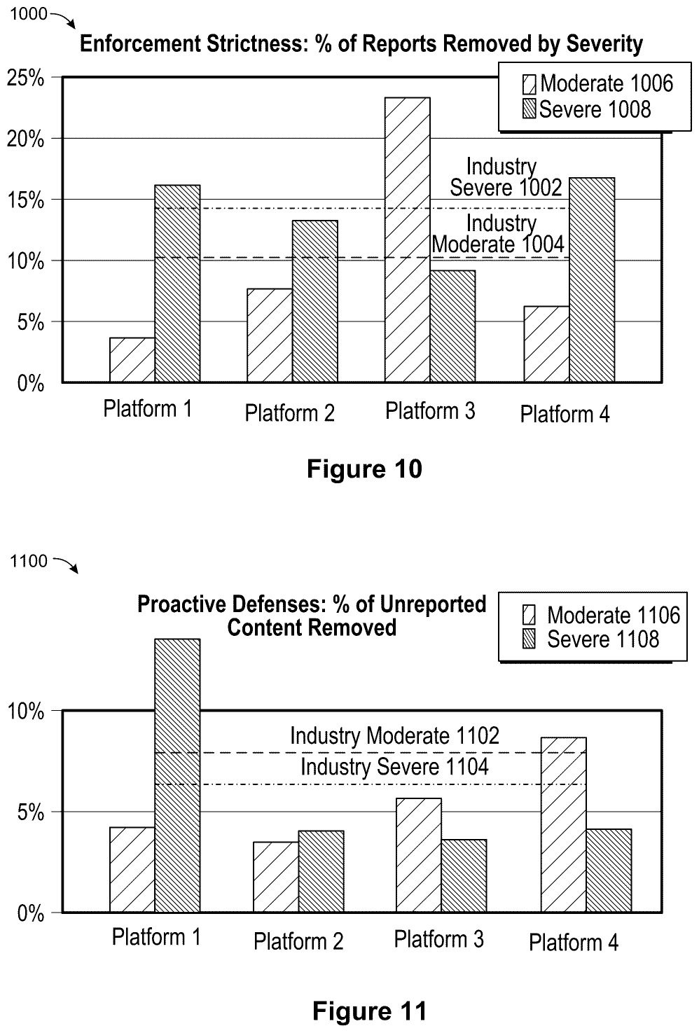

FIG. 10 shows an example visualization 1000 of enforcement strictness for the platforms 1, 2, 3, and 4 shown in FIGS. 8 and 9, according to some implementations. The visualization is a bar graph of percentage of reports removed by severity (either moderate 1006 or severe 1008). Averages for industry for enforcement strictness is shown by lines 1002 and 1004 for severe and moderate severity, respectively. FIG. 11 shows an example visualization 1100 of proactive defenses for the platforms 1, 2, 3, and 4 shown in FIGS. 8 and 9, according to some implementations. Averages for industry for enforcement strictness is shown by lines 1102 and 1104 for severe and moderate severity, respectively. The visualization is a bar graph of percentage of unreported reports removed by severity (either moderate 1106 or severe 1108).

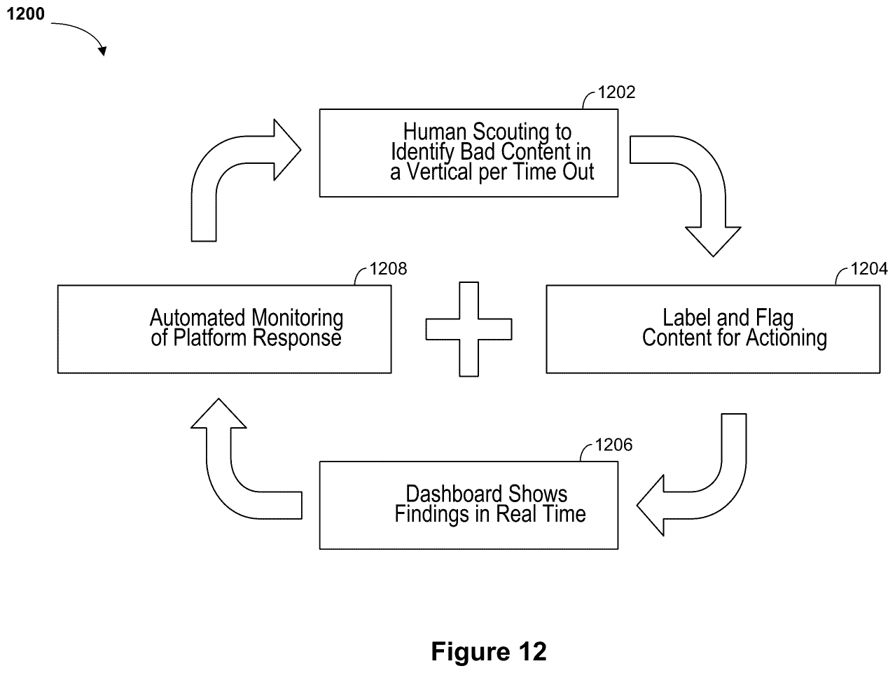

FIG. 12 shows a flow diagram of an example process 1200 for measuring and monitoring platform response, according to some implementations. Steps shown in FIG. 12 are performed by various modules of the computing system 200 described above. In some implementations, the steps include human scouting (1202) to identify bad content in a vertical per time out (e.g., for a given time period, such as 1 hour), the human scouts labelling and flagging (1204) content for actioning, a dashboard showing (1206) findings of objectionable content and/or platform response time metrics and categorization of content in real-time or near real-time, and automated monitoring (1208) of platform response.

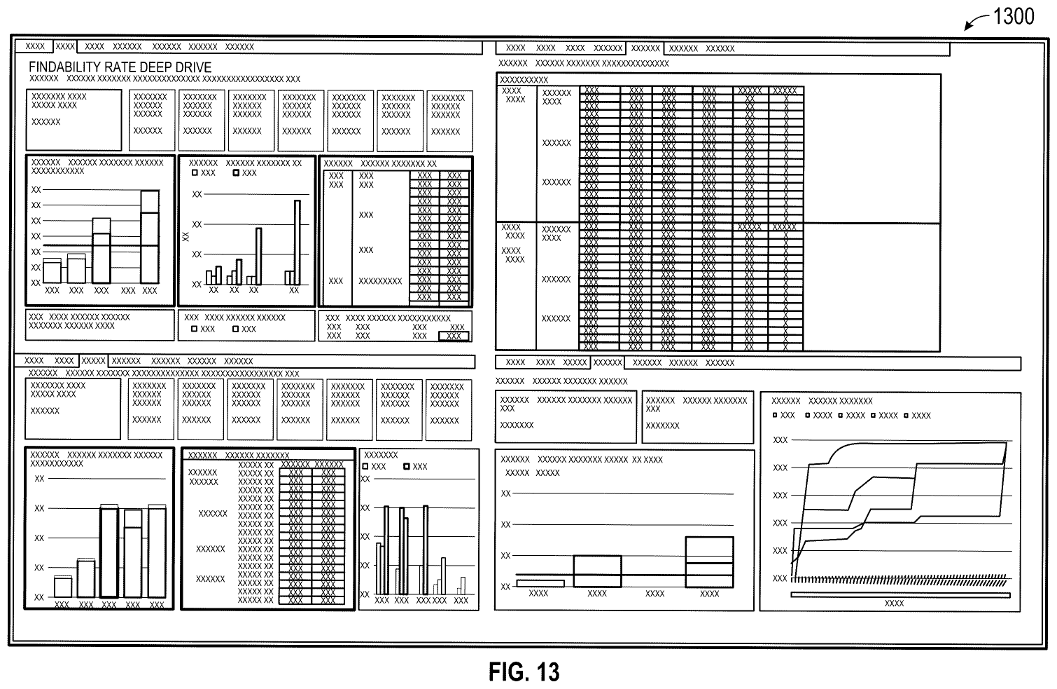

FIG. 13 is a graphical user interface with a dashboard 1300 that provides users of the system 200 with a visualization of findability rate, according to some implementations. In some implementations, the interface 1300 includes various metrics, graphs and appropriate scores, measures, and metrics, for dynamic visualization of detection, measurement, and/or mitigation of objectionable content, of online platforms.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method for detecting and measuring contentious multi-platform content and algorithmic bias, comprising:
recording any contentious content in one or more online platforms tagged by a plurality of users, while the plurality of users are searching the one or more online platforms according to a specified criteria;
analyzing actions of the one or more online platforms to determine an extent of contentious content in the one or more online platforms tagged by the plurality of users; and
generating a report indicating the extent of contentious content, for the one or more online platforms.

2. The method of claim 1, further comprising:
providing, to the plurality of users, an interface that specifies criteria for identifying contentious content in the one or more online platforms.

3. The method of claim 2, wherein the criteria specify (i) whether to search for specific text, images or other media snippets, or (ii) a narrative of abuse behavior, or entities or bad actors to search for, when searching the one or more online platforms.

4. The method of claim 1, wherein analyzing actions of the one or more online platforms comprises monitoring and reporting time taken by the one or more online platforms to take action on any contentious content tagged by the plurality of users.

5. The method of claim 1, wherein analyzing actions of the one or more online platforms comprises monitoring and reporting sharing, of any objectionable content that is tagged by the plurality of users, on the one or more online platforms.

6. The method of claim 1, wherein recording any contentious content tagged by the plurality of users is performed for a predetermined period of time.

7. The method of claim 1, wherein recording any contentious content tagged by the plurality of users includes obtaining screen shots of any tagged contentious content.

8. The method of claim 1, further comprising:
providing generic or predefined user profiles to ensure a realistic user experience for the plurality of users on the one or more online platforms.

9. The method of claim 1, further comprising:
disguising the plurality of users from the one or more online platforms by performing one or more operations selected from the group consisting of:
(i) providing generic or predefined user profiles;
(ii) refreshing a browser used by the plurality of users for searching the one or more online platforms, on a periodic basis;
(iii) rotating proxies, locations, or other geographic and device markers, used for browsing by the plurality of users; and
(iv) changing protocol used for browsing by the plurality of users.

10. The method of claim 1, further comprising:
obtaining labels, from the plurality of users, indicating severity of any contentious content tagged by the plurality of users, and using the labels to generate the report.

11. The method of claim 10, wherein the labels include a misinformation label, and the plurality of users assign the misinformation label based on an aggregate weighted score that includes absurdity, fairness, inauthenticity, or propensity for harm, of any contentious content tagged by the plurality of users.

12. The method of claim 10, further comprising:
processing the labels to ensure quality or consistency of labeling, by normalizing and combining the labels algorithmically into a single trust score, thereby labelling any tagged contentious content for severity.

13. The method of claim 10, wherein the labels are provided to the plurality of users, and include one or more labels selected from the group consisting of: content labels defined specifically for each category of abusive content, and risk labels within each content label, including permutations for different media formats, and languages in each abuse category.

14. The method of claim 1, further comprising:
generating synthetic content that includes one or more contentious content;
uploading the synthetic content using generic or pre-defined user profiles, to the one or more online platforms; and
measuring and reporting time taken by the one or more online platforms to remove the synthetic content.

15. The method of claim 1, further comprising:
reporting a contentious content, hosted by a target online platform and labeled, by the plurality of users, to have a minimum severity score, to the target online platform, using the target online platform's content moderation complaint mechanism.

16. The method of claim 15, further comprising:
monitoring the target online platform to determine a reaction time for the target online platform to remove the contentious content; and
generating the report for the target online platform further based on the reaction time.

17. The method of claim 1, further comprising:
computing and reporting one or more statistical insights on any contentious content tagged by the plurality of users.

18. The method of claim 1, further comprising:
reporting public perception of any contentious content tagged by the plurality of users.

19. An electronic device, comprising:
one or more processors; and
memory storing one or more programs for execution by the one or more processors, the one or more programs including instructions for:
recording any contentious content in one or more online platforms tagged by a plurality of users, while the plurality of users are searching the one or more online platforms according to a specified criteria;
analyzing actions of the one or more online platforms to determine an extent of contentious content in the one or more online platforms tagged by the plurality of users; and
generating a report indicating the extent of contentious content, for the one or more online platforms.

20. A non-transitory computer-readable storage medium storing one or more programs for execution by one or more processors of an electronic device, the one or more programs including instructions for:
recording any contentious content in one or more online platforms tagged by a plurality of users, while the plurality of users are searching the one or more online platforms according to a specified criteria;
analyzing actions of the one or more online platforms to determine an extent of contentious content in the one or more online platforms tagged by the plurality of users; and
generating a report indicating the extent of contentious content, for the one or more online platforms.
